(19) United States
(12) Patent Application Publication
(10) Pub. No.: US 2024/0345239 A1
(43) Pub. Date: Oct. 17, 2024

(54) VELOCITY ESTIMATION WITH RADIO FREQUENCY (RF) SENSING

(71) Applicant: QUALCOMM Incorporated, San Diego, CA (US)

(72) Inventors: Mohammad Tarek Fahim, San Diego, CA (US); Marwen Zorgui, San Diego, CA (US); Srinivas Yerramalli, San Diego, CA (US); Rajat Prakash, San Diego, CA (US); Xiaoxia Zhang, San Diego, CA (US)

(21) Appl. No.: 18/301,196

(22) Filed: Apr. 14, 2023

(51) Int. Cl. G01S 13/58; G01S 7/00; G01S 13/00

(52) U.S. Cl. CPC G01S 13/589; G01S 7/006; G01S 13/003

(57) ABSTRACT

This disclosure provides systems, methods, and devices for wireless communication that support a velocity estimation, such as a velocity estimation with radio frequency (RF) sensing. In a first aspect, a velocity of an object is determined based on doppler measurements from multiple transmission/reception points (TRPs). In a second aspect, the velocity of the object is determined based on angle of arrival (AoA) information received from multiple TRPs. The AoA information may include a range, an AoA, a time, or a combination thereof. In a third aspect, the velocity of the object is determined based on an orientation of the object during a sensing operation performed by a TRP. Other aspects and features are also claimed and described.

### TECHNICAL FIELD

Aspects of the present disclosure relate generally to wireless communication systems, and more particularly, to a velocity estimation, such as a velocity estimation with radio frequency (RF) sensing. Some features may enable and provide improved communications, including reduced control overhead, efficient resource utilization, improved ranging or velocity measurements, location determinations, transmission/reception point (TRP) selection, reduced interference, or a combination thereof.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

One or more devices of a wireless communication network may be configured to perform radio frequency (RF) sensing operations. RF sensing operations may be used in a variety of situations, such as monitoring status of the road to identify flooding, animal intruders, etc., identifying human activity or detecting an intruder at home, monitoring health, detecting an accident, as illustrative, non-limiting examples. Additionally, the RF sensing operation may be applicable to both indoor applications (e.g., estimating movement of a vehicle on a road) and outdoor applications (e.g., estimating movement of a vehicle in a factory).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication is performed by a network entity. The method includes receiving, from each transmit/receive point (TRP) of multiple TRPs, sensing information that indicates a range associated with an object and Doppler information. The method further includes determining, based on the sensing information received from the multiple TRPs, a velocity of the object.

In an additional aspect of the disclosure, an apparatus includes at least one processor and a memory coupled to the at least one processor. The at least one processor is configured to receive, from each TRP of multiple TRPs, sensing information that indicates a range associated with an object and Doppler information. The at least one processor is further configured to determine, based on the sensing information received from the multiple TRPs, a velocity of the object.

In an additional aspect of the disclosure, an apparatus includes an interface configured to receive, from each TRP of multiple TRPs, sensing information that indicates a range associated with an object and Doppler information. The apparatus further includes at least one processor coupled to a memory storing processor-readable code, the at least one processor configured to execute the processor-readable code to cause the at least one processor to determine, based on the sensing information received from the multiple TRPs, a velocity of the object.

In an additional aspect of the disclosure, an apparatus includes means for receiving, from each TRP of multiple TRPs, sensing information that indicates a range associated with an object and Doppler information. The apparatus further includes means for determining, based on the sensing information received from the multiple TRPs, a velocity of the object.

In an additional aspect of the disclosure, a non-transitory computer-readable medium stores instructions that, when executed by a processor, cause the processor to perform operations. The operations include receiving, from each TRP of multiple TRPs, sensing information that indicates a range associated with an object and Doppler information. The operations further include determining, based on the sensing information received from the multiple TRPs, a velocity of the object.

In an additional aspect of the disclosure, a method for wireless communication is performed by a network entity. The method includes transmitting, to each TRP of a set of TRPs, configuration information. The configuration information indicates sensing scheduling information. The method further includes receiving, from each TRP of the set of TRPs, sensing information associated with an object. The sensing information indicates a range value, an angle of arrival, and a time. The method also includes determining, based on the sensing information received from the set of TRPs, a velocity of the object.

In an additional aspect of the disclosure, an apparatus includes at least one processor and a memory coupled to the at least one processor. The at least one processor is configured to transmit, to each TRP of a set of TRPs, configuration information. The configuration information indicates sensing scheduling information. The at least one processor is further configured to receive, from each TRP of the set of TRPs, sensing information associated with an object. The sensing information indicates a range value, an angle of arrival, and a time. The at least one processor is also configured to determine, based on the sensing information received from the set of TRPs, a velocity of the object.

In an additional aspect of the disclosure, an apparatus includes a communication interface configured to transmit, to each TRP of a set of TRPs, configuration information. The configuration information indicates sensing scheduling information. The communication interface is further configured to receive, from each TRP of the set of TRPs, sensing information associated with an object. The sensing information indicates a range value, an angle of arrival, and a time. The apparatus further includes at least one processor coupled to a memory storing processor-readable code, the at least one processor configured to execute the processor-readable code to cause the at least one processor to determine, based on the sensing information received from the set of TRPs, a velocity of the object.

In an additional aspect of the disclosure, an apparatus includes means for transmitting, to each TRP of a set of TRPs, configuration information. The configuration information indicates sensing scheduling information. The apparatus further includes means for receiving, from each TRP of the set of TRPs, sensing information associated with an object. The sensing information indicates a range value, an angle of arrival, and a time.

The apparatus also includes means for determining, based on the sensing information received from the set of TRPs, a velocity of the object.

In an additional aspect of the disclosure, a non-transitory computer-readable medium stores instructions that, when executed by a processor, cause the processor to perform operations. The operations include transmitting, to each TRP of a set of TRPs, configuration information. The configuration information indicates sensing scheduling information. The operations further include receiving, from each TRP of the set of TRPs, sensing information associated with an object. The sensing information indicates a range value, an angle of arrival, and a time. The operations also include determining, based on the sensing information received from the set of TRPs, a velocity of the object.

In an additional aspect of the disclosure, a method for wireless communication is performed by a network entity. The method includes transmitting, to each TRP of a set of TRPs, configuration information. The configuration information indicates a measurement configuration associated with an object and indicates orientation estimation information. The method further includes receiving, from each TRP of the set of TRPs, sensing information associated with a sensing operation performed based on the measurement configuration. The sensing information indicates a velocity of the object determined based on the orientation estimation information.

In an additional aspect of the disclosure, an apparatus includes at least one processor and a memory coupled to the at least one processor. The at least one processor is configured to transmit, to each TRP of a set of TRPs, configuration information. The configuration information indicates a measurement configuration associated with an object and indicates orientation estimation information. The at least one processor is further configured to receive, from each TRP of the set of TRPs, sensing information associated with a sensing operation performed based on the measurement configuration. The sensing information indicates a velocity of the object determined based on the orientation estimation information.

In an additional aspect of the disclosure, an apparatus includes a communication interface configured to transmit, to each TRP of a set of TRPs, configuration information. The configuration information indicates a measurement configuration associated with an object and indicates orientation estimation information. The apparatus further includes at least one processor coupled to a memory storing processor-readable code, the at least one processor configured to execute the processor-readable code to cause the at least one processor to receive, from each TRP of the set of TRPs, sensing information associated with a sensing operation performed based on the measurement configuration. The sensing information indicates a velocity of the object determined based on the orientation estimation information.

In an additional aspect of the disclosure, an apparatus includes means for transmitting, to each TRP of a set of TRPs, configuration information. The configuration information indicates a measurement configuration associated with an object and indicates orientation estimation information. The apparatus further includes means for receiving, from each TRP of the set of TRPs, sensing information associated with a sensing operation performed based on the measurement configuration. The sensing information indicates a velocity of the object determined based on the orientation estimation information.

In an additional aspect of the disclosure, a non-transitory computer-readable medium stores instructions that, when executed by a processor, cause the processor to perform operations. The operations include transmitting, to each TRP of a set of TRPs, configuration information. The configuration information indicates a measurement configuration associated with an object and indicates orientation estimation information.

The operations further include receiving, from each TRP of the set of TRPs, sensing information associated with a sensing operation performed based on the measurement configuration. The sensing information indicates a velocity of the object determined based on the orientation estimation information.

In an additional aspect of the disclosure, a method for wireless communication is performed by a transmission/reception point (TRP). The method includes receiving, from a network entity, configuration information. The configuration information indicates a measurement configuration associated with an object and indicates orientation estimation information. Additionally the method includes transmitting, to the network entity, an indicator associated with a sensing operation performed based on the measurement configuration. The indicator indicates a velocity of the object determined based on the orientation estimation information.

In an additional aspect of the disclosure, an apparatus includes at least one processor and a memory coupled to the at least one processor. The at least one processor is configured to receive, from a network entity, configuration information. The configuration information indicates a measurement configuration associated with an object and indicates orientation estimation information. The at least one processor is further configured to transmit, to the network entity, an indicator associated with a sensing operation performed based on the measurement configuration. The indicator indicates a velocity of the object determined based on the orientation estimation information.

In an additional aspect of the disclosure, an apparatus includes at least one processor coupled to a memory storing processor-readable code, the at least one processor configured to execute the processor-readable code to cause the at least one processor to receive, from a network entity, configuration information. The configuration information indicates a measurement configuration associated with an object and indicates orientation estimation information. The apparatus further includes a communication interface configured to transmit, to the network entity, an indicator associated with a sensing operation performed based on the measurement configuration. The indicator indicates a velocity of the object determined based on the orientation estimation information.

In an additional aspect of the disclosure, an apparatus includes means for receiving, from a network entity, configuration information. The configuration information indicates a measurement configuration associated with an object and indicates orientation estimation information. The apparatus further includes means for transmitting, to the network entity, an indicator associated with a sensing operation performed based on the measurement configuration. The indicator indicates a velocity of the object determined based on the orientation estimation information.

In an additional aspect of the disclosure, a non-transitory computer-readable medium stores instructions that, when executed by a processor, cause the processor to perform operations. The operations include receiving, from a network entity, configuration information. The configuration information indicates a measurement configuration associated with an object and indicates orientation estimation information. The operations further include transmitting, to the network entity, an indicator associated with a sensing operation performed based on the measurement configuration. The indicator indicates a velocity of the object determined based on the orientation estimation information.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 shows a diagram illustrating an example disaggregated base station architecture according to one or more aspects.

FIG. 4 is a block diagram illustrating an example wireless communication system that supports a velocity estimation based on sensing information according to one or more aspects.

FIG. 5 is a conceptual diagram that supports a velocity estimation based on sensing information according to one or more aspects.

FIG. 6 is a conceptual diagram that supports a velocity estimation based on sensing information according to one or more aspects.

FIG. 7 is a conceptual diagram that supports a velocity estimation based on sensing information according to one or more aspects.

FIG. 8 is a conceptual diagram that supports a velocity estimation based on sensing information according to one or more aspects.

FIG. 9 is a conceptual diagram that supports a velocity estimation based on sensing information according to one or more aspects.

FIG. 10 is a ladder diagram illustrating an example of a velocity estimation based on sensing information according to one or more aspects.

FIG. 11 is a conceptual diagram that supports a velocity estimation based on sensing information according to one or more aspects.

FIG. 12 is a ladder diagram illustrating an example of a velocity estimation based on sensing information according to one or more aspects.

FIG. 13 is a flow diagram illustrating an example process that supports a velocity estimation based on sensing information according to one or more aspects.

FIG. 14 is a flow diagram illustrating an example process that supports a velocity estimation based on sensing information according to one or more aspects.

FIG. 15 is a flow diagram illustrating an example process that supports a velocity estimation based on sensing information according to one or more aspects.

FIG. 16 is a block diagram of an example network entity that supports a velocity estimation based on sensing information according to one or more aspects.

FIG. 17 is a flow diagram illustrating an example process that supports a velocity estimation based on sensing information according to one or more aspects.

FIG. 18 is a block diagram of an example transmission/reception point (TRP) that supports a velocity estimation based on sensing information according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support is a conceptual diagram that supports a velocity estimation based on sensing information. For example, in a first aspect, the present disclosure describes that a velocity of an object may be determined based on Doppler measurements from multiple transmission/reception points (TRPs). The Doppler measurements may be determined based on one or more monostatic sensing operations, one or more bistatic sensing operations, or a combination thereof. In a second aspect, the velocity of the object may be determined based on angle of arrival (AoA) information received from one or more TRPs. The AoA information may include a range, an AoA, a time, or a combination thereof. In a third aspect, the velocity of the object may be determined based on an orientation of the object during a sensing operation performed by a TRP.

Particular implementations of the subject matter described in this disclosure may be implemented to realize one or more of the following potential advantages or benefits. In some aspects, the present disclosure provides techniques for supporting a velocity estimation based on sensing information. For example, the techniques described herein enable sensing, such as RF sensing, to estimate a location or a velocity of an object. The techniques describe herein enable a Doppler measurement that indicates one component of the velocity of the object to be used to determine a true velocity of the object. For example, Doppler measurements from multiple TRPs may be used to determine the true velocity. Additionally, or alternatively, the Doppler measurement may be used in combination with an orientation of the object to determine a true velocity of the object.

The sensing may also be performed to determine AoA information, which may be used to determine the true velocity of the object.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology.

Additionally, one or more aspects of the present disclosure may be related to shared access to wireless spectrum between networks using different radio access technologies or radio air interfaces. [0057] 5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc.

In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

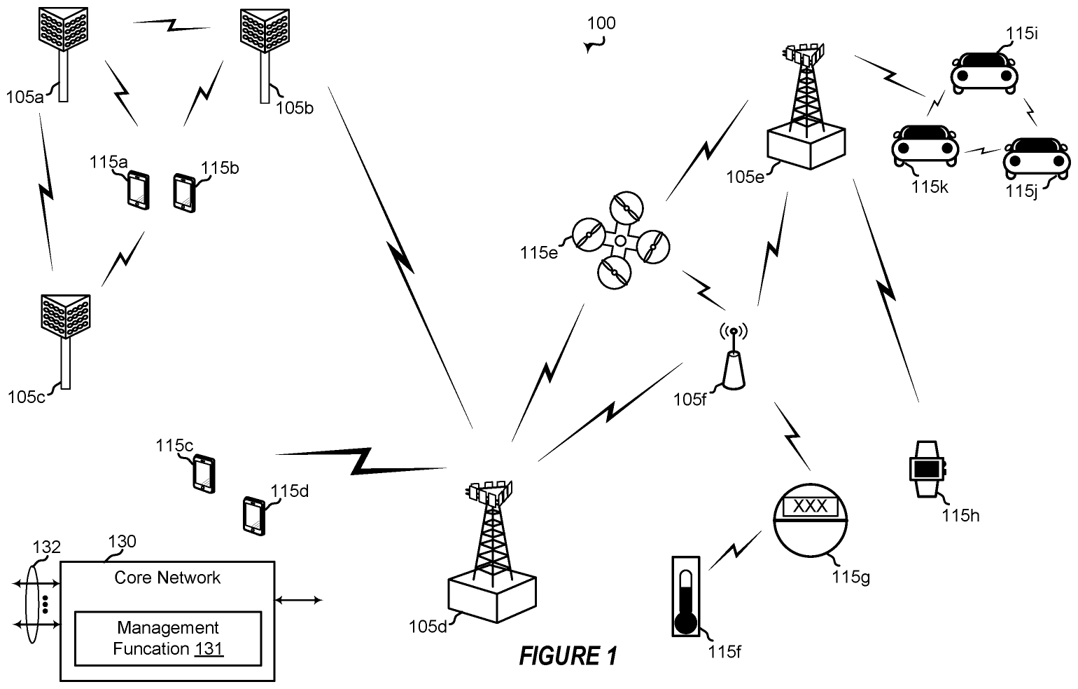

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like.

UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

Base stations 105 may communicate with a core network 130 and with one another. For example, base stations 105 may interface with the core network 130 through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via core network 130).

Core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

In some implementations, core network 130 includes or is coupled to a management function 131, which is an entity in the 5G Core Network (5GC) supporting various functionality. Management function 131 may include a Location Management Function (LMF) or a Sensing Management Function (SnMF). The SnMF may be configured to manage support for sensing operations for one or more sensing operations or sensing services for one or more devices, such as one or more UEs 115, one or more base stations 105, one or more TRPs, or a combination thereof. For example the SnMF may include one or more servers, such as multiple distributed servers. Base stations 105 may forward sensing messages to the SnMF and may communicate with the SnMF via a NR Positioning Protocol A (NRPPa). The SnMF is configured to control sensing parameters for UEs 115 and the SnMF can provide information to the base stations 105 and UE 115 so that action can be taken at UE 115, base station 105, or another device. The LMF may be configured to managing support for different location services for one or more UEs.

For example the LMF may include one or more servers, such as multiple distributed servers. Base stations 105 may forward location messages to the LMF and may communicate with the LMF via a NR Positioning Protocol A (NRPPa). The LMF is configured to control the positioning parameters for UEs 115 and the LMF can provide information to the base stations 105 and UE 115 so that action can be taken at UE 115.

In some implementations, UE 115 and base station 105 are configured to communicate with management function 131 via an Access and Mobility Management Function (AMF).

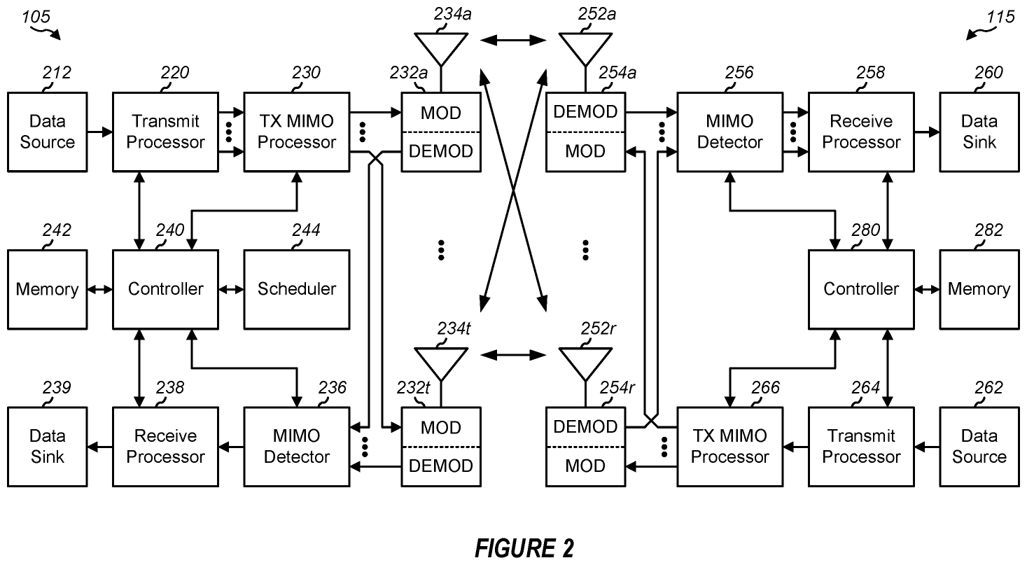

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc.

The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal.

Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIG. 12-15 or 17, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

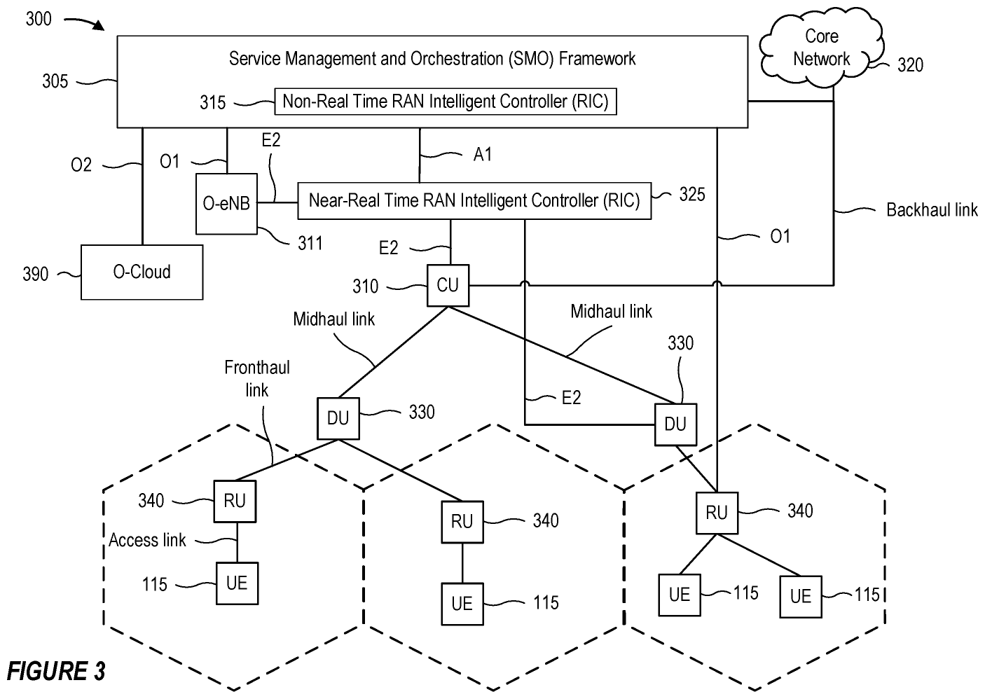

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). Core network 320 may include or correspond to core network 130. A CU 310 may communicate with one or more distributed units (DUs) 330 via respective midhaul links, such as an F1 interface.

The DUs 330 may communicate with one or more radio units (RUs) 340 via respective fronthaul links. The RUs 340 may communicate with respective UEs 115 via one or more radio frequency (RF) access links. In some implementations, the UE 115 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 115. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as Al policies).

As described herein, a node (which may be referred to as a node, a network node, a network entity, or a wireless node) may include, be, or be included in (e.g., be a component of) a base station (e.g., any base station described herein), a transmission and reception point (TRP), a UE (e.g., any UE described herein), a network controller, an apparatus, a device, a computing system, an integrated access and backhauling (IAB) node, a distributed unit (DU), a central unit (CU), a remote unit (RU), a core network, a LFM, and/or a another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

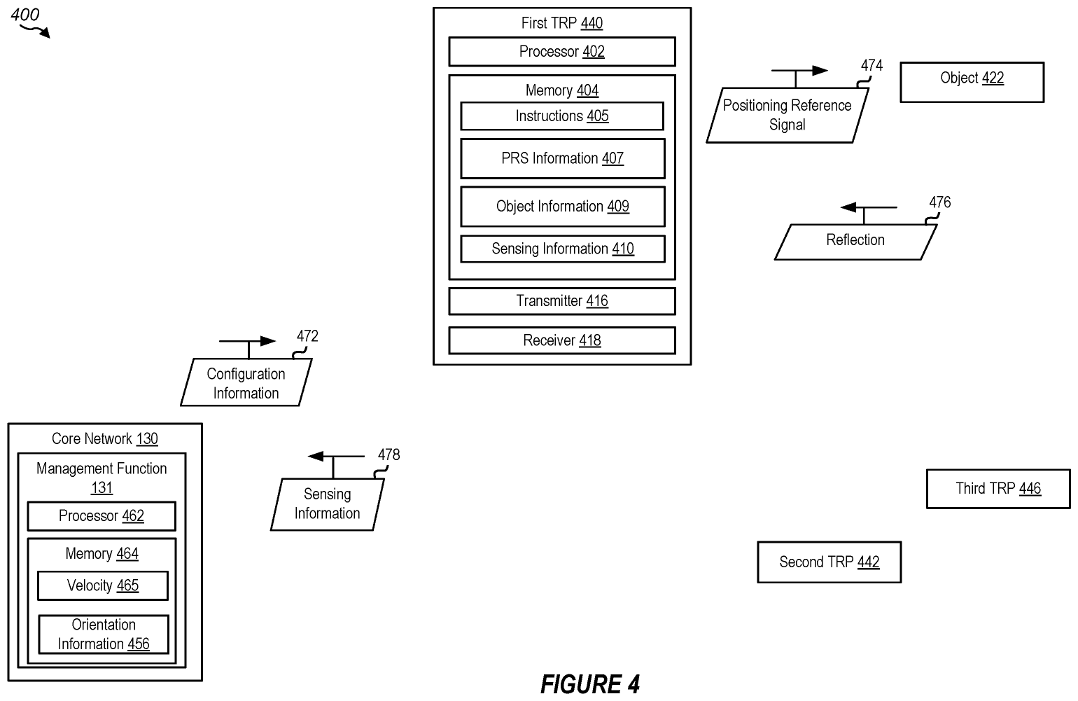

FIG. 4 is a block diagram of an example wireless communications system 400 that supports a velocity estimation based on sensing information according to one or more aspects. In some examples, wireless communications system 400 may implement aspects of wireless network 100. Wireless communications system 400 includes a first TRP 440, a second TRP 442, a third TRP 446, and core network 130. Although three TRPs are illustrated, in some other implementations, wireless communications system 400 may generally include fewer or more than three TRPs. Additionally, an environment of wireless communications system 400 may include an object 422.

Object 422 may be device free object, not equipped with communication of sensing (RF) functionality. For example, object may be a person, an animal, a car, etc.

First TRP 440 may include a variety of components (such as structural, hardware components) used for carrying out one or more functions described herein. For example, these components may include one or more processors 402 (hereinafter referred to collectively as “processor 402”), one or more memory devices 404 (hereinafter referred to collectively as “memory 404”), one or more transmitters 416 (hereinafter referred to collectively as “transmitter 416”), and one or more receivers 418 (hereinafter referred to collectively as “receiver 418”). In some implementations, first TRP 440 may include an interface (e.g., a communication interface) that includes transmitter 416, receiver 418, or a combination thereof. Additionally, or alternatively, first TRP 440 may include a sensing device that includes transmitter 416, receiver 418, or a combination thereof. Processor 402 may be configured to execute instructions 405 stored in memory 404 to perform the operations described herein. In some implementations, processor 402 includes or corresponds to one or more of receive processor 238, transmit processor 220, and controller 240, and memory 404 includes or corresponds to memory 242.

Memory 404 includes or is configured to store instructions 405, position reference signal (PRS) information 407, object information 409, and sensing information 410. PRS information 407 includes information that first TRP 440 uses to generate a positioning reference signal (PRS) 474. For example, PRS information 407 may include one or more parameters, such as a time, a repetition rate, a bandwidth configuration, a comb pattern configuration, or a combination thereof. The repetition rate may include or indicate a number of times within a time period that a PRS is transmitted. The comb pattern may include or indicate a configurable resource block allocation. Object information 409 includes or corresponds to information about object 422. For example, object information 409 may include or indicate an object ID of object 422, an RF-signature of object 422, or a combination thereof. Sensing information 410, such as measurement information, may include or correspond to a result of one or more sensing operations. For example, sensing information may include a range, an angle (e.g., an AoA), a time, a location, a Doppler measurement, a RSRP level, a velocity, or a combination thereof.

Transmitter 416 is configured to transmit reference signals, control information and data to one or more other devices, and receiver 418 is configured to receive references signals, synchronization signals, control information and data from one or more other devices.

For example, transmitter 416 may transmit signaling, control information and data to, and receiver 418 may receive signaling, control information and data from, core network 130, another TRP, or a network entity. Additionally, or alternatively transmitter 416 may transmit a positioning reference signal (e.g., 474) and receiver 418 may receive a reflection signal (e.g., 476). In some implementations, transmitter 416 and receiver 418 may be integrated in one or more transceivers. Additionally, or alternatively, transmitter 416 or receiver 418 may include or correspond to one or more components of as described with reference to UE 115 or base station 105 of FIG. 2. In some implementations, transmitter 416 and receiver 418 may be configured to operate in a full duplex mode.

In some implementations, first TRP 440 may include one or more antenna arrays. The antenna array may include multiple antenna elements configured to perform wireless communications with other devices, such as with core network 130. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

Second TRP 442 and third TRP 446 may include or correspond to first TRP 440. For example, second TRP 442 or third TRP 446 may include one or more similar components as first TRP 440. In some implementations, first TRP 440, second TRP 442, or third TRP 446 may be synchronized, such as time synchronized. Additionally, or alternatively, first TRP 440, second TRP 442, or third TRP 446 may be configured to share the same coordinate system.

Core network 130 may include a 3GPP core network, a 4G core network, a 5G core, or an evolved packet core (EPC). Core network 130 may be coupled, such as communicatively coupled, to one or more network entities, such as TRP 440, 442, or 446.

Core network 130 may include MF 131.

Although shown and described as being included in core network 130, MF 131 may be distinct from core network 130 in some implementations. For example the MF 131 may include one or more servers, such as multiple distributed servers. MF 131 may be configured to support various functionality, such as managing support for different location services for one or more UEs, managing support for different sensing services for one or more UEs or device. For example, MF 131 is configured to control sensing parameters for TRP 440, 442, or 446 and MF 131 can provide information to TRP 440, 442, or 446 so that action or operation can be taken at TRP 440, 442, or 446. TRPs 440, 442, or 446, such as base station 105, may forward sensing messages to the MF 131 and may communicate with the MF 131 via a protocol, such as a NR Positioning Protocol A (NRPPa). In some implementations, TRP 440, 442, or 446, or a combination thereof are configured to communicate with the MF 131 via an Access and Mobility Management Function (AMF).

MF 131 may include a variety of components (such as structural, hardware components) used for carrying out one or more functions described herein. For example, these components may include one or more processors 462 (hereinafter referred to collectively as “processor 462”), one or more memory devices 464 (hereinafter referred to collectively as “memory 464”), one or more transmitters, and one or more receivers. In some implementations, LMF 431 may include an interface (e.g., a communication interface) that includes the one or more transmitters, the one or more receivers, or a combination thereof. Processor 462 may be configured to execute instructions stored in memory 464 to perform the operations described herein. In some implementations, with reference to components of base station 105 of FIG. 2, processor 462 includes or corresponds to one or more of receive processor 238, transmit processor 220, and controller 240, and memory 454 includes or corresponds to memory 242.

Memory 464 may include or indicate a velocity 465 of object 422 and orientation information 456. In some implementations, velocity 465 may be a true velocity.

Orientation information 456 may include or indicate a pose estimation model or a pose estimation neural network, an orientation estimation model or an orientation estimate neural network, or a combination thereof. In some implementations, MF 131 of core network 130 may be configured to determine velocity 465 of object 422 based on sensing information 478 from one or more TRPs. Moreover, LMF 131 may be configured to transmit velocity data that indicates velocity 465.

In some implementations, wireless communications system 400 implements a 5G NR network. For example, wireless communications system 400 may include multiple 5G-capable UEs 115 and multiple 5G-capable base stations 105, such as UEs and base stations configured to operate in accordance with a 5G NR network protocol such as that defined by the 3GPP. In some other implementations, wireless communications system 400 implements a 6G network.

During operation of wireless communications system 400, core network 130 (or management function 131) may transmit configuration information 472 to one or more TRPs, such as TRPs 440, 442, or 446. TRP 440 may perform one or more sensing operations based on configuration information 472, PRS information 407, or a combination thereof. In some implementations, TRP 440 may transmit positioning reference signal 474 and receive reflection 476, which is a reflection of positioning reference signal 474 off of object 422. TRP may perform one or measurement operations or calculations based on positioning reference signal 474, receive reflection 476, or a combination thereof to generate sensing information 410. TRP 440 may generate sensing information 478 based on sensing information 410 and transmit sensing information 478 to core network 130 (or MF 131). Core network 130 (or MF 131) may determine velocity 465 based on sensing information 748.

As described herein, the present disclosure provides techniques for supporting a sensing charging subscription. The techniques described provide processes, information, and signaling for supporting a velocity estimation based on sensing information. For example, the techniques described herein enable sensing, such as RF sensing, to estimate a location or velocity 465 of object 422. The techniques describe herein enable a Doppler measurement that indicates one component of the velocity of object 422 to be used to determine a true velocity of object 422. For example, Doppler measurements from multiple TRPs (e.g., 440, 442, 446) may be used to determine the true velocity. The sensing may also be performed to determine AoA information, which may be used to determine the true velocity of object 422. Additionally, or alternatively, the Doppler measurement may be used in combination with an orientation of object 422 to determine a true velocity of object 422.

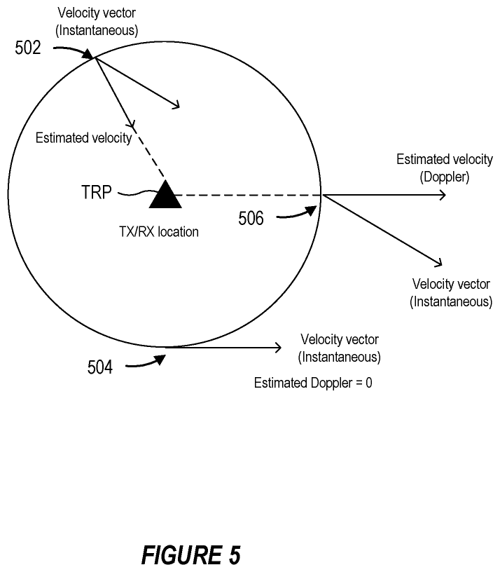

In some implementations, velocity 465 may be determined or estimated based on one or more sensing operations, such as one or more RF-sensing operations. The one or more sensing operations, such as monostatic sensing operation, a bistatic sensing operation, or a combination thereof, may be performed to determine a location of object 422, a Doppler estimation (e.g., a Doppler measurement), or a combination thereof. Examples of such techniques are described further herein at least with reference to FIGS. 5-7.

Referring to FIG. 5, FIG. 5 is a conceptual diagram that supports a velocity estimation based on sensing information according to one or more aspects. FIG. 5 includes a TRP at a location (TX/RX location). FIG. 5 also indicates possible positions of an object, such as object 422. For example, the object may be positioned at a first location 502, a second location 504, or a third location 506. At each location (e.g., 502, 504, 506), the object may have a velocity vector (e.g., an instantaneous velocity).

The TRP may be configured to perform a sensing operation (e.g., an RF sensing operation) to determine a Doppler measurement. An estimated velocity of the object may be determined based on the Doppler measurement. The estimated velocity may be a projection of the velocity vector v (instantaneous) in a radial direction with respect to the location of the TRP. Since the radial direction is a function of the relative location of the object with respect to the location of the TRP, the estimated velocity is also a function of the relative location of the object. With respect to the first location 502, the estimated velocity is toward the TRP. With respect to the second location 504, the estimated velocity is zero because the velocity vector is in a direction is perpendicular (e.g., tangential) to the radial direction of the TRP. With respect to the third location 506, the estimated velocity is way from the TRP.

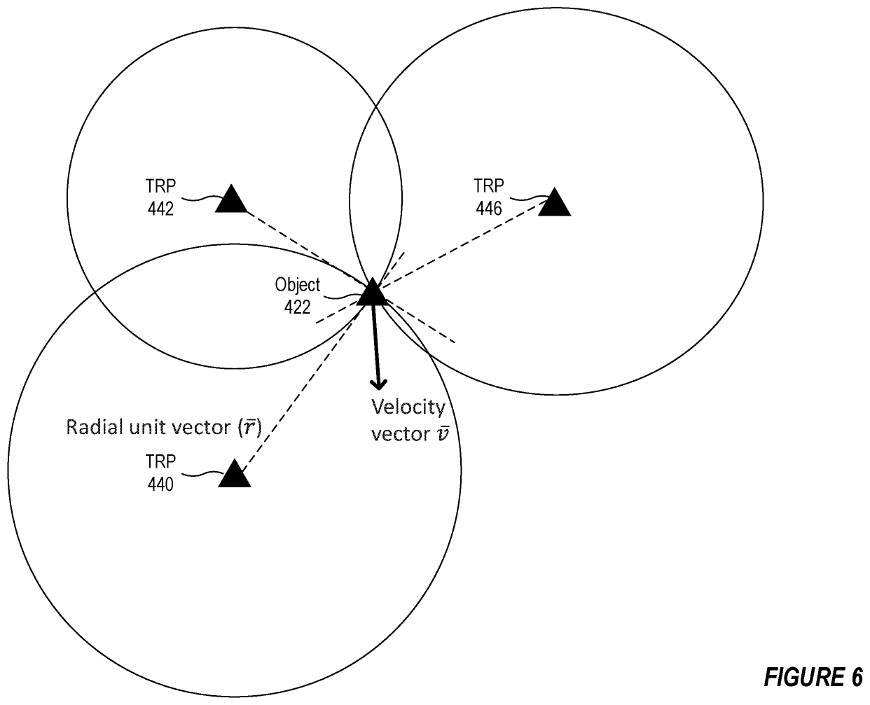

Referring to FIG. 6, FIG. 6 is a conceptual diagram that supports a velocity estimation based on sensing information according to one or more aspects. FIG. 6 includes TRPs 440, 442, and 446 and object 422. As shown in FIG. 6, each TRP is configured to perform a monostatic sensing operation (e.g., a monostatic RF sensing operation). Object 422 may have a velocity vector v̅. The velocity vector v̅ may include components in three dimensions vₓ, v_{y}, v_{z} such that that v̅=(vₓ, v_{y}, v_{z}).

To determine the velocity vector, the position of object 422 is determined using one or more ranging measurement. If there are multiple objects, then range measurements across TRPs are associated and position estimates for the multiple objects are computed. For each TRP, a radial direction may be computed based on a location of the TRP and the location estimate of object 422. To illustrate, the radial direction for TRP 440 is r̅₁, the radial direction for TRP 442 is r̅₂, and the radial direction for TRP 446 is r̅₃.

Each TRP may perform a sensing operation and may determine an estimated velocity based on a doppler measurement. For example, TRP 440 may determine a first estimated velocity v₁, TRP 442 may determine a second estimated velocity v₂, and TRP 446 may determine a third estimated velocity v₃. In some implementations, each TRP may determine a Doppler measurement and translate the Doppler measurement into a projected velocity v̅. r̅. It is noted that, for a monostatic Doppler measurement:

$$\\ {f}_{d} = \frac{2 ( \overline{v} \cdot \overline{r} )}{c} {f}_{c} ,$$

where f_{d} is the Doppler frequency (e.g., of reflection 476), c is the speed of light, and f_{c} is the carrier frequency of the reference signal (e.g., 474).

In some implementations, the estimated velocity of a TRP may be considered a noisy measurement, such that a projected velocity v̅. r̅ is equal to an estimated velocity plus some noise of the TRP. For example, TRP 440 may determine be associated with a first noise n₁, TRP 442 may be associated with a second noise n₂, and TRP 446 may be associated with a third noise n₃. In some implementations, the noise level for each velocity measurement may be inversely proportional to the signal to noise ratio (SNR) of the received reference signal. Accordingly, for TRPs 440, 442, 446, the respective measurement equations may be generated:

$$\begin{matrix}\\ \\ \begin{matrix}\overline{v} \cdot \overline{{r}_{1}} = {v}_{1} + {n}_{1} \\ \overline{v} \cdot \overline{{r}_{2}} = {v}_{2} + {n}_{2} \\ \overline{v} \cdot \overline{{r}_{3}} = {v}_{3} + {n}_{3}\end{matrix}\end{matrix}$$

Each equation includes, on the righthand side, a noisy velocity projection based on a Doppler measurement and, on the lefthand side, a radial vector.

The velocity vector V including the three components vₓ, v_{y}, v_{z} may then be solved for based on the equations to determine velocity 465, such as the true velocity parameters.

For example, a least square (LS) operation or a minimum mean-square error (MMSE) operation may be performed to estimate the true velocity parameters. In some implementations, the MMSE operation may be performed if a noise variance is known.

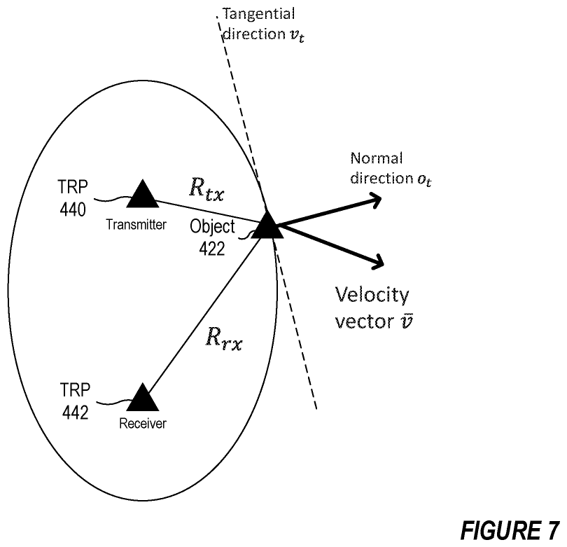

Referring to FIG. 7, FIG. 7 is a conceptual diagram that supports a velocity estimation based on sensing information according to one or more aspects. FIG. 7 includes TRPs 440, 442 and object 422. As shown in FIG. 7, TRPs 440 and 442 are positioned at different locations and configured as a TRP pair to perform a bistatic sensing operation (e.g., a bistatic RF sensing operation). For example, TRP 440 is configured as a transmitter and TRP 442 is configured as a receiver.

Referring to FIG. 7, Rₜₓ is a range from TRP 440 to object 422 and Rᵣₓ is a range from TRP 442 to object 422. Object 422 may have a velocity vector V. The velocity vector V may include components in three dimensions vₓ, v_{y}, v_{z} such that that v̅=(vₓ, v_{y}, v_{z}) Additionally, a tangent unit vector vₜ may pass through object 422 and an ellipse established based on TRPs 440 and 442, and a Doppler measurement may be measured in a direction orthogonal to tangent vector (normal vector) oₜ. Stated differently, the Doppler measurement would be a projection of the true velocity on a line orthogonal to the tangent to the ellipse represented by the sum of range Rₜₓ plus range Rᵣₓ. It is noted that, for a bistatic Doppler measurement:

$$\\ {f}_{d} = \frac{1}{c} \frac{d}{dt} ( {R}_{tx} + {R}_{rx} ) {f}_{c}$$

Three TRP pairs that perform bistatic sensing operations may enable measurement equations to generated, such as:

$$\begin{matrix}\\ \\ \begin{matrix}\overline{v} \cdot \overline{{o}_{t , 1}} = {v}_{1} + {n}_{1} \\ \overline{v} \cdot \overline{{o}_{t , 2}} = {v}_{2} + {n}_{2} \\ \overline{v} \cdot \overline{{o}_{t , 3}} = {v}_{3} + {n}_{3}\end{matrix}\end{matrix}$$

Once the measurement equations are written, a similar procedure may be used as described with reference to monostatic operations to determine the velocity of object 422. In some implementations, a combination of monostatic sensing and bistatic sensing operations may be performed to determine the velocity of object 422. For example, one or more measurement equations described with reference to FIG. 6 and one or more measurement equations described with reference to FIG. 7 may be used to determine the velocity of object 422.

Referring again to FIG. 4, in some implementation, a velocity of object 422 may be determined by a network, such as core network 130 or management function 131, such as a Sensing Management Function (SnMF). For example, the network may determine the velocity with the assistance of one or more TRPs, such as one or more UEs 115, one or more base stations 105, or a combination thereof. The network may configuration a reporting session for a set of TRPs, where a TRP may include a single TRP or a TRP pair.

Each TRP that participates in the sensing session may be configured to report a range, an angle, a Doppler measurement or a phase, or a combination thereof. In some implementations, a TRP may be configured to report a Doppler measurement for each multipath delay. Additionally, it is noted that if a phase for a multipath is reported, the network may compute the Doppler measurement.

In some implementations, if a location of a TRP (e.g., a UE) is unknown, the network may determine or compute the location of the TRP. In some implementations, the location of the TRP may be determined or coordinated by a LMF.

The network may compute a location of object 422 based on multipath delays, angles (e.g., AoAs), or a combination thereof received from the TRPs. In some implementations, a number of objects in an environment is unknown. Accordingly, the network may have to perform a process, such as execute a data association algorithm, to assign one or more measurements to different objects. Accordingly, prior to determining a velocity of object 422, the network may first have to determine which measurements are associated with object 422 and the location of object 422.

Based on the location of object 422 and the location of the TRPs, the network may compute a velocity measurement direction (e.g., a radial direction) of a TRP and associate the radial direction of the TRP with the Doppler measurement reported by the TRP. The network may determine a velocity vector v of object 422 based on the radial directions and Doppler measurements of multiple TRPs, such as three or more TRPs. The network may transmit an indicator that indicates the determined velocity to another device, such as a device that request velocity information.

In some implementations, one or more operations described with reference to the network, such as core network 130 or management function 131, may be performed by a TRP, such as UE 115. In such implementations, sensing information 478 (e.g., locations, measurements, or a combination thereof), may be provided to a particular TRP, such as a particular UE. For example, the sensing information 478 may be provided to the particular TRP over a sidelink channel (e.g., between two UEs) or from first UE to the particular TRP via the network using an LPPa/NRPPa protocol. The particular TRP may process the received sensing information 478 to determine velocity 465.

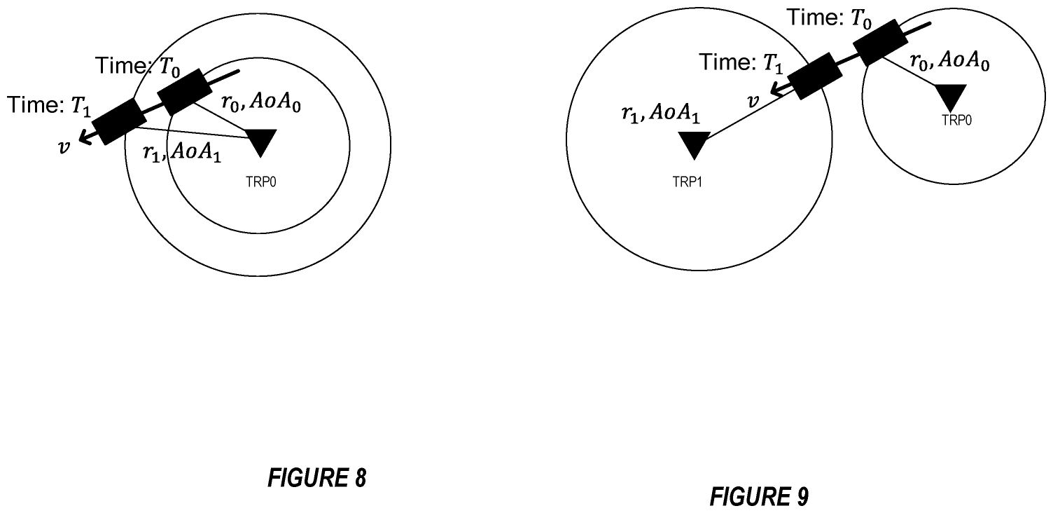

In some implementations, velocity 465 may be determined or estimated based on one or more sensing operations, such as one or more RF-sensing operations. For example, the one or more sensing operations may be performed to determine an AoA. Examples of such techniques are described further herein at least with reference to FIGS. 8-10.

Referring to FIG. 8, FIG. 8 is a conceptual diagram that supports a velocity estimation based on sensing information according to one or more aspects. FIG. 8 includes a TRP (TRP0) and a target (e.g., an object). TRP (TRP0) may include or correspond to TRP 440. The object may include or correspond to object 422. As shown in FIG. 8, the object is shown at two different times—e.g., a first time T₀ and a second time T₁.

The TRP may be configured to determine an angle of arrival (AoA) that may be used to determine a velocity v (e.g., a true velocity) of the object. To illustrate, at the first time T₀, the TRP may perform a sensing operation. For example, the TRP may transmit a PSR or other reference signal, such as positioning reference signal 474, and receive a reflection, such as 476. Based on the sensing operation (e.g., the reflection), the TRP may estimate a first range r₀ and a first angle of arrival AoA₀ (θ₀, ϕ₀). At the second time T₁, the TRP transmit another PRS (e.g., 474) and estimates a second range r₁ and a second angle of arrival AoA₁=(θ₁, ϕ₁). Based on T₀, T₁, r₀, r₁, AoA₀, AoA₁, velocity v (e.g. the true velocity) can be computed. For example, the velocity v may be calculated using the closed-form expression:

$$\\ v = \frac{\sqrt{{( {r}_{1} sin ( {ϕ}_{1} ) cos ( {θ}_{1} ) - {r}_{0} sin ( {ϕ}_{0} ) cos ( {θ}_{0} ) )}^{2} + {( {r}_{1} sin ( {ϕ}_{1} ) sin ( {θ}_{1} ) - {r}_{0} sin ( {ϕ}_{0} ) sin ( {θ}_{0} ) )}^{2} + {( {r}_{1} cos ( {ϕ}_{1} ) - {r}_{0} cos ( {ϕ}_{0} ) )}^{2}}}{{T}_{1} - {T}_{0}}$$

In some implementations, a single TRP may perform the measurements at the first time T₀ and the second time T₁. Although two times are described with reference to FIG. 8, in other implementations, the single TRP may perform additional measurements, such as at a third time T₂, which may also be used to determine the velocity v. Additionally, or alternatively, in other implementations, different or multiple TRPs may perform the measurements at the first time T₀, the second time T₁, or a combination thereof. Using additional measurements, using multiple TRPs at a time, or both, may provide a more estimated velocity, such as the velocity v.

Referring to FIG. 9, FIG. 9 is a conceptual diagram that supports a velocity estimation based on sensing information according to one or more aspects. FIG. 9 includes a first TRP (TRP0), a second TRP (TRP1), and a target (e.g., an object). First TRP (TRP0) may include or correspond to TRP 440 and second TRP (TRP1) may include or correspond to TRP 442. The object may include or correspond to object 422. As shown in FIG. 9, the object is shown at two different times—e.g., a first time T₀ and a second time T₁.

The first TRP may be configured to perform a first sensing operation at the first time T₀. For example, the first TRP may transmit a PRS, such as positioning reference signal 474, and receive a reflection, such as 476. Based on the sensing operation (e.g., the reflection), the first TRP may estimate a first range rₒ and a first angle of arrival AoAₒ(θ₀, ϕ₀).

At the second time T₁, the second TRP may transmit a PRS (e.g., 474) and estimate a second range r₁ and a second angle of arrival AoA₁=(θ₁, ϕ₁). Based on T₀, T₁, r₀, r₁, AoA₀, AoA₁, velocity v (e.g. the true velocity) can be computed. To compute the velocity v using the closed-form expression (above), the first TRP and the second TRP should be time synchronized and share the same coordinate systems.

Although two times are described with reference to FIG. 9, in other implementations, the TRP may perform additional measurements, such as at a third time T₂, which may also be used to determine the velocity v. In other implementations, different or multiple TRPs may perform the measurements at the first time T₀, the second time T₁, or a combination thereof. For example, both the first TRP and the second TRP may perform measurements at the first time T₀ and the second time T₁. Using additional measurements, using multiple TRPs at a time, or both, may provide a more estimated velocity, such as the velocity v.

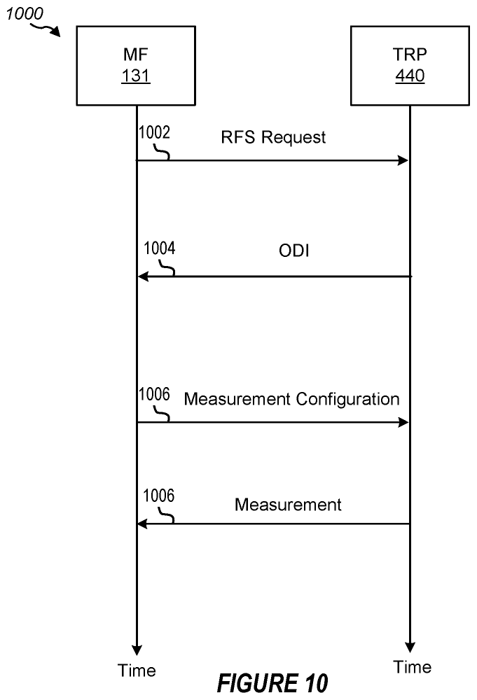

FIG. 10 is ladder diagram illustrating an example of a velocity estimation based on sensing information according to aspects of the present disclosure. As shown in FIG. 10, system 1000 of the ladder diagram of FIG. 10 includes MF 131 and TRP 440. MF 131 and TRP 440 may include one or more components and be configured to perform one or more operations, as described with reference to FIGS. 1-4. System 1000 may include or correspond to wireless communication system 100 or 400. While FIG. 10 depicts singular TRP 440, system 1000 may include more than one TRP.

Referring to FIG. 10, during operation of system 1000, at 1002, MF 131 transmits an RF-sensing (RFS) request. The RFS request may be associated with performing a sensing operation to detect an object, such as object 422, to determine a velocity of the object, or a combination thereof. The RFS request may include or indicate an object ID of the object, an RF-signature of the object, or a combination thereof. The object ID, the RF-signature, or a combination thereof, may include or correspond to object information 409. Although shown as the RFS request being sent to a single TRP, in other implementations, MF 131 may send the RFS request to multiple TRPs.

In some implementations, MF 131 may transmit the RFS request based on or in response to a request, such as from an application, to detect an object and determine a velocity of the object. The application may include a program or software. In some implementations, the application includes functionality to track or monitor an object or area. The application may be executed by or at a device, such as a computer or server, UE 115, base station 105, or TRP 440, 442, 446, as illustrative, non-limiting examples. In some implementations, the request to determine the velocity of the object may be a request to determine a true velocity of the object, e.g., not an estimate velocity based on a single Doppler measurement.

At 1004, TRP 440 transmits an object detection indicator (ODI) to MF 131. For example, the ODI may be transmitted by TRP 440 based on or in response to detection of the RF-signature by the TRP 440. To illustrate, based on the RFS request, TRP 440 may perform an sensing operation and detect the RF-signature of the object based on the sensing operation. In some implementations, the ODI may include or indicate the object ID of the object, an object detection flag, an RSRP level associated with the object, or a combination thereof. Although shown as a single TRP transmitting the ODI, in other implementations, multiple TRPs that each detect the RF signature of the object may transmit an ODI.

At 1006, MF 131 selects a set of TRPs and sends each TRP of the set of TRPs a measurement configuration. For example, MF 131 may select the set of TRPs based on the received ODI. In some implementations, the set of TRPs includes a single TRP. The measurement configuration may include or correspond to configuration information 472, PRS information 407, or a combination thereof. In some implementations, the measurement configuration includes or indicates timing or ordering of measurements to be performed by one or more TRPs of the set of TRPs. In some implementations, based on the measurement configuration, TRP 440 may perform one or more sensing operations.

At 1008, TRP 440 transmits measurement information. For example, the measurement information may include or correspond to sensing information 410 or sensing information 478. In some implementations, the measurement information includes or indicates a range value, an AoA measurement, a time value (e.g., a timestamp), or a combination thereof. In some implementations, the measurement information may not include a time value and a time value associated with the measurement information may be assumed to be a time associated with the measurement configuration, such as a time at which TRP 440 was scheduled or instructed to perform a sensing operation.

Based on the measurement information, MF 131 may determine a velocity of the object. For example, the velocity may include or correspond to velocity 465. In some implementations, MF 131 may calculate the velocity, such as a true velocity, based on measurements received from multiple TRPs, such as three different TRPs.

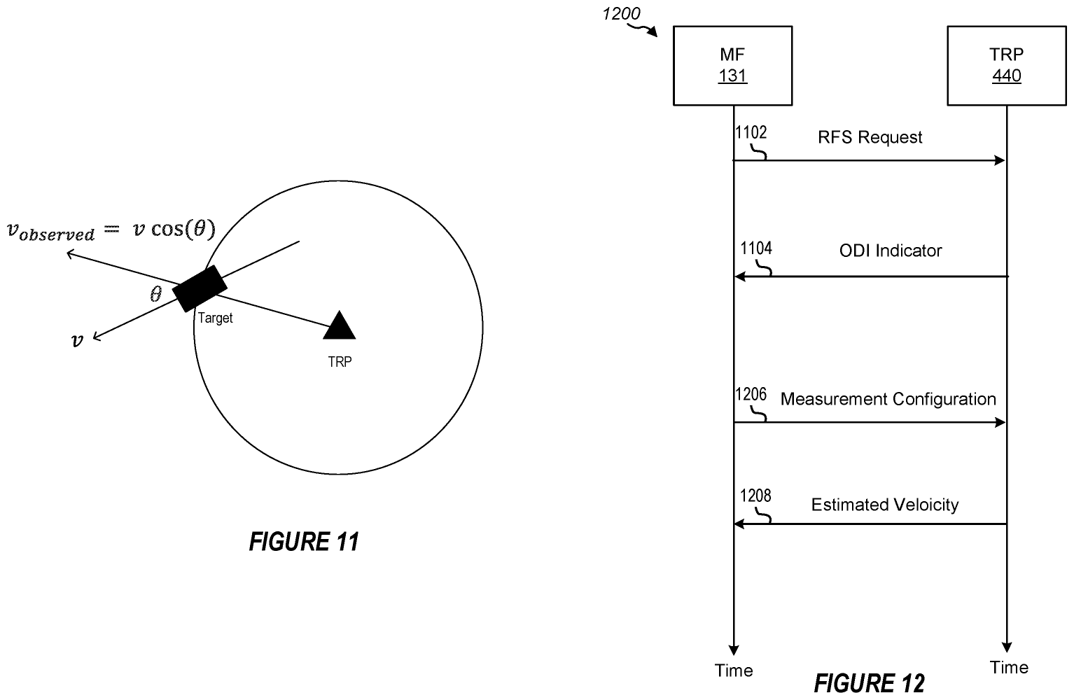

Referring again to FIG. 4, in some implementations, velocity 465 may be determined or estimated based on one or more sensing operations, such as one or more RF-sensing operations. For example, the one or more sensing operations may be performed or the velocity 465 may be determined based on an orientation of object 422. Examples of such techniques are described further herein at least with reference to FIGS. 11 and 12.

Referring to FIG. 11, FIG. 11 is a conceptual diagram that supports a velocity estimation based on sensing information according to one or more aspects. FIG. 11 includes a TRP and a target (e.g., an object). TRP may include or correspond to TRP 440. The object may include or correspond to object 422.

Estimation of a true velocity v of the object may be based on an orientation of the object. It is noted that an AoA determined by the TRP with respect to the object is a function of the relative position of the object with respect to the TRP. However, the TRP may determine the same AoA for the object when the object is in different orientations.

As shown in FIG. 11, the object is traveling with a velocity v. TRP may be configured to perform a sensing operation, such as an RF sensing operation, to determine an estimate velocity based on estimating a Doppler frequency shift associated with the object. While the true velocity is v, the Doppler frequency is an estimated projection of the true velocity, where the estimated velocity (e.g., the projected velocity in the radial direction) is v_{observed}. The true velocity v_{observed} may be determined based on v_{observed} and an orientation θ of the object. For example, the true velocity v may be determined based on:

$$\\ v = \frac{{v}_{observed}}{cos ( θ )} .$$

In some implementations, the TRP may be configured to determine v_{observed} based on doppler shift measurements, can be obtained. Additionally, or alternatively, the TRP may determine or receive an indication of an orientation θ (e.g., an orientation estimate) of the object. For example, the TRP may perform one or more operations to determine the orientation θ (e.g., an orientation estimate) of the object. To illustrate, the TRP may receive an RF signal, such as reflection 476, and may determine a 3D pose (e.g., a 3D pose estimate) of the object based on the RF signal.

In some implementations, the TRP may use machine learning (ML) to determine the 3D pose of the object. For example, the TRP may use a pose estimation model or a pose estimation neural network to determine the 3D pose of the object. Additionally, or alternatively, the TRP may determine the orientation θ (e.g., an orientation estimate) of the object based on the 3D pose (e.g., the 3D pose estimate) of the object. In some implementations, the TRP may use machine learning (ML) to the orientation θ of the object. For example, the TRP may use an orientation estimation model or an orientation estimation neural network to determine the orientation θ of the object. The TRP may determine the velocity based on v_{observed} and the orientation θ (e.g., the orientation estimate) of the object.

In some implementations, the TRP may transmit an indicator that includes or indicates the velocity v, v_{observed}, orientation θ, or a combination thereof to core network 130 or management function 131. The indicator may include or correspond to sensing information 478. Core network 130 or management function 131 may determine a velocity (e.g., a final velocity), such as velocity 465, based on sensing information (e.g., 478) received from one or more TRPs. Using information from multiple TRPs may include an accuracy of the velocity determination by Core network 130 or management function 131. In some implementations, the final velocity value may be an average velocity value, a maximum velocity value, a minimum velocity value, a median velocity value, or a combination thereof.

FIG. 12 is ladder diagram illustrating an example of a velocity estimation based on sensing information according to aspects of the present disclosure. As shown in FIG. 12, system 1200 of the ladder diagram of FIG. 12 includes MF 131 and TRP 440. MF 131 and TRP 440 may include one or more components and be configured to perform one or more operations, as described with reference to FIGS. 1-4. System 1200 may include or correspond to wireless communication system 100 or 400. While FIG. 12 depicts singular TRP 440, system 1200 may include more than one TRP.

Referring to FIG. 12, during operation of system 1200, at 1202, MF 131 transmits an RF-sensing (RFS) request. The RFS request may be associated with performing a sensing operation to detect an object, such as object 422, to determine a velocity of the object, or a combination thereof. The RFS request may include or indicate an object ID of the object, an RF-signature of the object, or a combination thereof. The object ID, the RF-signature, or a combination thereof, may include or correspond to object information 409. Although shown as the RFS request being sent to a single TRP, in other implementations, MF 131 may send the RFS request to multiple TRPs.

In some implementations, MF 131 may transmit the RFS request based on or in response to a request, such as from an application, to detect an object and determine a velocity of the object. The application may include a program or software. In some implementations, the application includes functionality to track or monitor an object or area. The application may be executed by or at a device, such as a computer or server, UE 115, base station 105, or TRP 440, 442, 446, as illustrative, non-limiting examples. In some implementations, the request to determine the velocity of the object may be a request to determine a true velocity of the object, e.g., not an estimate velocity based on a single Doppler measurement.

At 1204, TRP 440 transmits an object detection indicator (ODI) to MF 131. For example, the ODI may be transmitted by TRP 440 based on or in response to detection of the RF-signature by the TRP 440. To illustrate, based on the RFS request, TRP 440 may perform an sensing operation and detect the RF-signature of the object based on the sensing operation. In some implementations, the ODI may include or indicate the object ID of the object, an object detection flag, an RSRP level associated with the object, or a combination thereof. Although shown as a single TRP transmitting the ODI, in other implementations, multiple TRPs that each detect the RF signature of the object may transmit an ODI.

At 1206, MF 131 selects a set of TRPs and sends each TRP of the set of TRPs a measurement configuration. For example, MF 131 may select the set of TRPs based on the received ODI. In some implementations, the set of TRPs includes a single TRP. The measurement configuration may include or correspond to configuration information 472, PRS information 407, or a combination thereof. In some implementations, the measurement configuration includes or indicates timing or ordering of measurements to be performed by one or more TRPs of the set of TRPs. Additionally, or alternatively, the measurement configuration may include or indicate orientation information, such as orientation information 456. The orientation information may include or indicate a pose estimation model or a pose estimation neural network, an orientation estimation model or an orientation estimate neural network, or a combination thereof.

In some implementations, based on the measurement configuration, TRP 440 may perform one or more sensing operations. Additionally, or alternatively, TRP 440 may perform orientation estimation, determine or estimate a velocity of the object, or a combination thereof. In some implementations, the velocity determined or estimated by TRP 440 may be a true velocity.

At 1208, TRP 440 transmits a velocity value, such as an estimated velocity, to MF 131. MF 131 may receive one or more velocity values (e.g., one or more estimated velocity value) and may be configured to compute a final velocity value based on the one or more velocity values. The final velocity value may include or correspond to velocity 465. In some implementations, the final velocity value may be an average velocity value, a maximum velocity value, a minimum velocity value, a median velocity value, or a combination thereof.

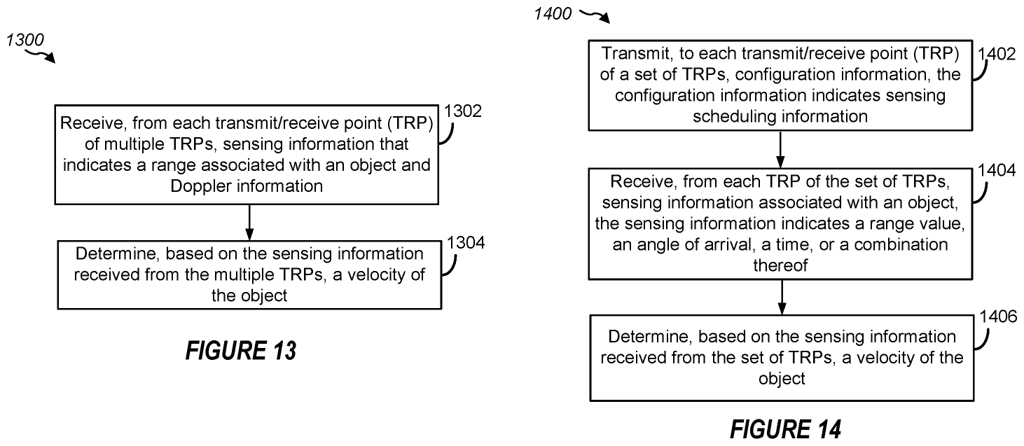

FIG. 13 is a flow diagram illustrating an example process 1300 that supports a velocity estimation based on sensing information according to one or more aspects. Operations of process 1300 may be performed by a network entity, such as core network 130, management function 131, UE 115, base station 105, or TRP 440, 442, 446, or a network entity as described with reference to FIG. 16. For example, example operations of process 1300 may enable the network entity to support a velocity estimation based on sensing information.

At block 1302, a network entity receiving, from each TRP of multiple TRPs, sensing information that indicates a range associated with an object and Doppler information. The multiple TRPs include or correspond to TRPs 440, 442, or 446. The sensing information may include or correspond to sensing information 410 or sensing information 478. In some implementations, the sensing information from each TRP of the multiple TRPs includes or indicates an angle. Additionally, or alternatively, the Doppler information may include or indicate a phase, a Doppler measurement, or a combination thereof

At block 1304, the network entity determining, based on the sensing information received from the multiple TRPs, a velocity of the object. The velocity may include or correspond to velocity 465. The object may include or correspond to object 422.

In some implementations, the network entity determines, based on the sensing information received from a first TRP of the multiple TRPs, a phase indicated by the Doppler information included in the sensing information received from the first TRP. The network entity may calculate a Doppler measurement associated with the first TRP based on the phase.

In some implementations, the network entity associates different ranges of the sensing information from the multiple TRPs to different objects of multiple objects. The multiple objects include the object and another object. For example, the multiple objections may include object 422 or another object. The network entity may determine a location of the object based on a first range indicated by the sensing information from the multiple TRPs and associated with the object. Additionally, or alternatively, the network entity may determine a location of the other object based on a second range indicated by the sensing information from the multiple TRPs and associated with the other object.

In some implementations, the network entity determines a location of the object based on at least one range indicated by the sensing information from the multiple TRPs. The network entity may determine, for each TRP of the multiple TRPs, a location of the TRP. The network entity may determine, for each TRP of the multiple TRPs, a radial direction of the TRP based on the location of the TRP and the location of the object. For each TRP of the multiple TRPS, the network entity may associate the radial direction of the TRP and a Doppler measurement based on the Doppler information. In some implementations, the radial direction of the TRP include a velocity measurement direction of the TRP. In some implementations, to determine the velocity of the object, the network entity performs an LS operation or an MMSE operation using the associated radial direction and Doppler measurement for each TRP of the multiple TRPs. the velocity of the object includes a vector having multiple components.

In some implementations, the network entity receives, from an application, a request for the velocity of the object. The application may include a program or software. In some implementations, the application includes functionality to track or monitor an object or area. The application may be executed by or at a device, such as a computer or server, UE 115, base station 105, or TRP 440, 442, 446, as illustrative, non-limiting examples. The network entity may transmit configuration information to each TRP of the multiple TRPs to configure multiple TRPs to participate in a sensing session. The configuration information may include or correspond to configuration information 472, PRS information 407, object information, or a combination thereof. In some implementations, the network entity may transmit, to the application, a report that indicates the velocity of the object.

In some implementations, the network entity transmits configuration information to a first TRP of the multiple TRPS. The configuration information may indicate that the first TRP is to participate in a sensing session and perform a monostatic sensing operation. The sensing information received from the first TRP may be based on the monostatic sensing operation. Additionally, or alternatively, in some implementations, the network entity transmits configuration information to a second TRP of the multiple TRPS. The second TRP may include a TRP pair including a transmit TRP and a receive TRP. In some such implementations, the configuration information indicates that the second TRP is to participate in a sensing session and perform a bistatic sensing operation. The sensing information received from the second TRP may be based on the bistatic sensing operation.

FIG. 14 is a flow diagram illustrating an example process 1400 that supports a velocity estimation based on sensing information according to one or more aspects. Operations of process 1400 may be performed by a network entity, such as core network 130, management function 131, UE 115, base station 105, or TRP 440, 442, 446, or a network entity as described with reference to FIG. 16. For example, example operations of process 1400 may enable the network entity to support a velocity estimation based on sensing information.

At block 1402, a network entity transmits, to each TRP of a set of TRPs, configuration information. The set of TRPs include or correspond to TRPs 440, 442, or 446. The configuration information may include or correspond to configuration information 472, PRS information 407, object information 409, or a combination thereof. The configuration information may include or indicate sensing scheduling information. For example, the sensing scheduling information may include or indicate a timing or order for one or more TRPs to perform sensing operations. The set of TRPs may include a single TRP or multiple TRPs. In implementations where the set of TRPs include multiple TRPs, the set of TRPs may be time synchronized, share the same coordinate system, or a combination thereof.

At block 1404, the network entity receive, from each TRP of the set of TRPs, sensing information associated with an object. The object may include or correspond to object 422. The sensing information may include or correspond to sensing information 478, sensing information 410, velocity 465, or a combination thereof. In some implementations, the sensing information includes or indicates a range value, an angle of arrival, a time, or a combination thereof.

At block 1406, the network entity determine, based on the sensing information received from the set of TRPs, a velocity of the object. The velocity may include or correspond to velocity 465.

In some implementations, the network entity transmits a request to one or more TRPs. The request indicates an object ID of an object, an RF-signature associated with the object, or a combination. The object ID, the RF-signature, or a combination thereof, may include or correspond to object information 409. The network entity may receive, from at least one TRP of the one or more TRPs, a response to the request. The response may indicate the object ID, an object detection indicator, an RSRP level associated with the object, or a combination thereof. The network entity may select the set of TRPs from the one or more TRPs based on the response.

In some implementations, the set of TRPS includes a first TRP. To receive the sensing information, the network entity may receive first sensing information from the first TRP. The first sensing information may indicate a first range value, a first angle of arrival, and a first time. Additionally, or alternatively, to receive the sensing information, the network entity may receive second sensing information from the first TRP. The second sensing information may indicate a second range value, a second angle of arrival, and a second time. The first time is different from the second time.

In some implementations, the set of TRPS includes a second TRP. To receive the sensing information, the network entity may receive third sensing information from the second TRP. The third sensing information may indicate a third range value, a third angle of arrival, and a third time. In some implementations, the third time is different from the first time or the second time. In other implementations, the third time is the same as the first time.

In some implementations, the network entity receives the first sensing information from the first TRP and receives the third sensing information from the third TRP. In some such implementations, the third time (indicated by the third sensing information) is the same as or different from the first time (indicated by the first sensing information).

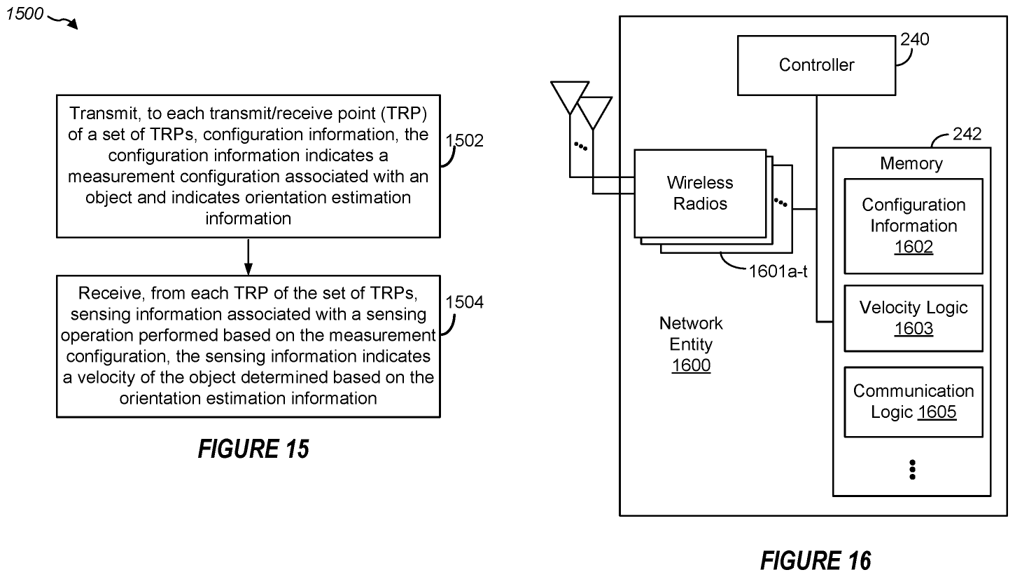

FIG. 15 is a flow diagram illustrating an example process 1500 that supports a velocity estimation based on sensing information according to one or more aspects. Operations of process 1500 may be performed by a network entity, such as core network 130, management function 131, UE 115, base station 105, or TRP 440, 442, 446, or a network entity as described with reference to FIG. 16. For example, example operations of process 1500 may enable the network entity to support a velocity estimation based on sensing information.

At block 1502, the network entity transmits, to each TRP of a set of TRPs, configuration information. The set of TRPs include or correspond to TRPs 440, 442, or 446. The configuration information may include or correspond to configuration information 472, PRS information 407, object information 409, or a combination thereof. The configuration information may indicate a measurement configuration associated with an object and may indicate orientation estimation information. The measurement configuration may include or correspond to configuration information 472, prs information 407, object information 407, or a combination thereof. The orientation estimation information may include or correspond to orientation information 456. In some implementations, the orientation estimation information may include one or more models. The one or more models including a pose estimation model, an orientation estimation model, or a combination thereof.

At block 1504, the network entity receives, from each TRP of the set of TRPs, sensing information associated with a sensing operation performed based on the measurement configuration. The sensing information may include or correspond to sending information 410, sensing information 478, or velocity 465. The sensing information may indicate a velocity of the object determined based on the orientation estimation information. In some implementations, the network entity determines a final velocity of the object based on, for each TRP of the set of TRPs, the velocity of the object indicated by the sensing information received from the TRP.

In some implementations, the network entity transmits a request to one or more TRPs. The request may indicate an object ID of the object, an RF-signature associated with the object, or a combination thereof. The object ID, the RF-signature, or a combination thereof, may include or correspond to object information 409. Additionally, or alternatively, the network entity receives, from at least one TRP of the one or more TRPs, a response to the request. The response may indicate the object ID, an object detection indicator, an RSRP level associated with the object, or a combination thereof. Then network entity may select the set of TRPs from the one or more TRPs based on the response.

FIG. 16 is a block diagram of an example network entity 1600 that supports a velocity estimation based on sensing information according to one or more aspects. Network entity 1600 may include or correspond to core network 130, management function 131, UE 115, base station 105, or TRP 440, 442, 446. Network entity 1600 may be configured to perform operations, including the blocks of processes 1300, 1400, or 1500. In some implementations, network entity 1600 includes the structure, hardware, and components shown and described with reference to base station 105 or UE 115 of FIG. 1, 2, or 4. As an illustrative example, network entity 1600 may include controller 240, which operates to execute logic or computer instructions stored in memory 242, as well as controlling the components of network entity 1600 that provide the features and functionality of network entity 1600. Network entity 1600, under control of controller 240, transmits and receives signals via wireless radios 1601a-t and antennas 234a-t. Wireless radios 1601a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include configuration information 1602, velocity logic 1603, and communication logic 1605. Configuration information 1602 may include or correspond may include or correspond to configuration information 472, PRS information 407, object information 409, or orientation information 456. Velocity logic 1603 may be configured to determine a velocity of an object, such as velocity 465. Communication logic 1605 may be configured to enable communication between network entity 1600 and one or more other devices. Network entity 1600 may receive signals from or transmit signals to one or more devices, such as base station 105, UE 115, core network 130, management function 131, TRP 440, 442, or 446, or another device.

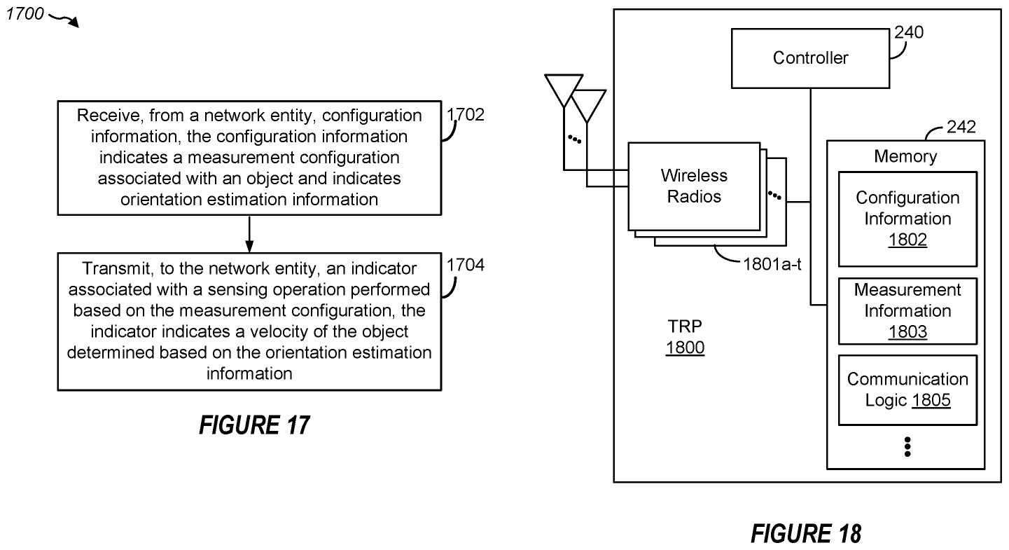

FIG. 17 is a flow diagram illustrating an example process 1700 that supports a velocity estimation based on sensing information according to one or more aspects. Operations of process 1700 may be performed by a TRP, such as UE 115, base station 105, or TRP 440, 442, 446, or a TRP as described with reference to FIG. 18. For example, example operations of process 1700 may enable the TRP to support a velocity estimation based on sensing information.

At block 1702, the TRP receiving, from a network entity, configuration information. The network entity may include or correspond to core network 130, management function 131, or another device. The configuration information may include or correspond to configuration information 472, orientation information 456, PRS information 407, or object information 409. The configuration information may indicate a measurement configuration associated with an object and indicate orientation estimation information. The object may include or correspond to object 422. The measurement configuration may include or correspond to PRS information 407 or object information 409. The orientation estimation information may include or correspond to orientation information 456. In some implementations, the orientation estimation information may include one or more models. The one or more models including a pose estimation model, an orientation estimation model, or a combination thereof.

At block 1704, the TRP transmitting, to the network entity, an indicator associated with a sensing operation performed based on the measurement configuration. The indicator may include or correspond to sensing information 410 or sensing information 478. The indicator may indicate a velocity of the object determined based on the orientation estimation information. The velocity may include or correspond to velocity 465.

In some implementations, the TRP performs the sensing operation based on the measurement configuration. The TRP may determine the velocity of the object based on the sensing operation. In some implementations, the sensing operation may include transmitting a positioning reference signal and receiving a reflection of the positioning reference signal. The positioning reference signal and the reflection may include or correspond to positioning reference signal 474 and reflection 476, respectively. Additionally, or alternatively, the TRP may determine a channel frequency response based on the sensing operation, such as based on the reflection. The TRP may determine, based on the orientation estimation information, a 3D pose estimate of the object based on the channel frequency response. For example, the 3D pose estimate may be determined based on a pose estimation model or a pose estimation neural network. The TRP may determine, based on the orientation estimation information, an orientation estimate based on the 3D pose estimate. For example, the orientation estimate may be determined based on an orientation estimation model or an orientation estimate neural network. The TRP may calculate the velocity of the object based on the orientation estimate.

In some implementations, the TRP receives, from the network entity, a sensing request that indicates an object ID of the object, an RF-signature associated with the object, or a combination thereof. The object ID, the RF-signature, or a combination thereof may include or correspond to object information 409. The TRP may detect the object based on the RF-signature. Additionally, or alternatively, the TRP may transmit, based on detection of the object, a response to the sensing request. The response may include or correspond to sensing information 478. The response may indicate the object ID, an object detection indicator, a reference signal received power (RSRP) level associated with the object, or a combination thereof.

FIG. 18 is a block diagram of an example TRP 1800 that supports a velocity estimation based on sensing information according to one or more aspects. TRP 1800 may include or correspond to UE 115, base station 105, or TRP 440, 442, 446. TRP 1800 may be configured to perform operations, including the blocks of processes 1700. In some implementations, TRP 1800 includes the structure, hardware, and components shown and described with reference to base station 105 or UE 115 of FIG. 1 or 2. As an illustrative example, TRP 1800 may include controller 240, which operates to execute logic or computer instructions stored in memory 242, as well as controlling the components of TRP 1800 that provide the features and functionality of TRP 1800. TRP 1800, under control of controller 240, transmits and receives signals via wireless radios 1801a-t and antennas 234a-t. Wireless radios 1801a-t include various components and hardware, as illustrated in FIG. 2 for base station 105, including modulator and demodulators 232a-t, transmit processor 220, TX MIMO processor 230, MIMO detector 236, and receive processor 238. Additionally, or alternatively, signals transmitted or received via wireless radios 1801a-t may include sensing signals, such as RF sensing signals.

As shown, the memory 242 may include configuration information 1802, measurement information 1803, and communication logic 1805. Configuration information 1802 may include or correspond to configuration information 472, PRS information 407, object information 409, or orientation information 456. Measurement information 1803 may include or correspond to sending information 410 or sensing information 478, or velocity 465. Communication logic 1805 may be configured to enable communication between TRP 1800 and one or more other devices. TRP 1800 may receive signals from or transmit signals to one or more devices, such as base station 105, UE 115, core network 130, management function 131, TRP 440, 442, or 446, or another device.

It is noted that one or more blocks (or operations) described with reference to FIG. 13-15 or 17 may be combined with one or more blocks (or operations) described with reference to another of the figures. For example, one or more blocks (or operations) of FIG. 13 may be combined with one or more blocks (or operations) of FIG. 14. As another example, one or more blocks associated with FIG. 13 or 14 may be combined with one or more blocks associated with FIG. 15. As another example, one or more blocks associated with FIG. 13, 14, or 15 may be combined with one or more blocks associated with FIG. 17. As another example, one or more blocks associated with FIG. 13-15 or 17 may be combined with one or more blocks (or operations) associated with FIG. 1-4, 10, or 12. Additionally, or alternatively, one or more operations described above with reference to FIGS. 1-4 may be combined with one or more operations described with reference to FIG. 16 or 18.

In one or more aspects, techniques for supporting a velocity estimation based on sensing information may include additional aspects, such as any single aspect or any combination of aspects described below or in connection with one or more other processes or devices described elsewhere herein. In a first aspect, techniques for supporting a velocity estimation based on sensing information may include receiving, from each TRP of multiple TRPs, sensing information that indicates a range associated with an object and Doppler information. The techniques may further include determining, based on the sensing information received from the multiple TRPs, a velocity of the object. In some examples, the techniques in the first aspect may be implemented in a method or process. In some other examples, the techniques of the first aspect may be implemented in a communication device, which may include a network entity or a component of a network entity. In some examples, the communication device may include at least one processing unit or system (which may include an application processor, a modem or other components) and at least one memory device coupled to the processing unit. The processing unit may be configured to perform operations described herein with respect to the communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a communication interface) that includes a transmitter, a receiver, or a combination thereof. Additionally, or alternatively, the wireless communication device may include one or more means configured to perform operations described herein.

In a second aspect, in combination with the first aspect, the sensing information from each TRP of the multiple TRPs includes an angle.

In a third aspect, in combination with the first aspect or the second aspect, the techniques further include the Doppler information indicates a phase, a Doppler measurement, or a combination thereof.

In a fourth aspect, in combination with one or more of the first aspect through the third aspect, the network entity includes a user equipment, a network, or a management function.

In a fifth aspect in combination with one or more of the first aspect through the fourth aspect, the techniques further include determining, based on the sensing information received from a first TRP of the multiple TRPs, a phase indicated by the Doppler information included in the sensing information received from the first TRP.

In a sixth aspect, in combination with the fifth aspect, the techniques further include calculating a Doppler measurement associated with the first TRP based on the phase.

In a seventh aspect, in combination with one or more of the first aspect through the sixth aspect, the techniques further include associating different ranges of the sensing information from the multiple TRPs to different objects of multiple objects, the multiple objects including the object and another object.

In an eighth aspect, in combination with the seventh aspect, the techniques further include determining a location of the object based on a first range indicated by the sensing information from the multiple TRPs and associated with the object.

In a ninth aspect, in combination with the eighth aspect, the techniques further include determining a location of the other object based on a second range indicated by the sensing information from the multiple TRPs and associated with the other object.

In a tenth aspect, in combination with one or more of the first aspect through the fourth aspect, the techniques further include determining a location of the object based on at least one range indicated by the sensing information from the multiple TRPs.

In an eleventh aspect, in combination with the tenth aspect, the techniques further include determining, for each TRP of the multiple TRPs, a location of the TRP.

In a twelfth aspect, in combination with the eleventh aspect, the techniques further include determining, for each TRP of the multiple TRPs, a radial direction of the TRP based on the location of the TRP and the location of the object.

In a thirteenth aspect, in combination with the twelfth aspect, the techniques further include, for each TRP of the multiple TRPS, associating the radial direction of the TRP and a Doppler measurement based on the Doppler information.

In a fourteenth aspect, in combination with the thirteenth aspect, the radial direction of the TRP include a velocity measurement direction of the TRP.

In a fifteenth aspect, in combination with the fourteenth aspect, to determine the velocity of the object, the techniques further include performing an LS operation or an MMSE operation using the associated radial direction and Doppler measurement for each TRP of the multiple TRPs.

In a sixteenth aspect, in combination with the sixteenth aspect, the velocity of the object includes a vector having multiple components.

In a seventeenth aspect, in combination with one or more of the first aspect through the sixteenth aspect, the techniques further include receiving, from an application, a request for the velocity of the object.

In an eighteenth aspect, in combination with the seventeenth aspect, the techniques further include transmitting configuration information to each TRP of the multiple TRPs to configure multiple TRPs to participate in a sensing session.

In a nineteenth aspect, in combination with the eighteenth aspect, the techniques further include transmitting, to the application, a report that indicates the velocity of the object.

In a twentieth aspect, in combination with one or more of the first aspect through the nineteenth aspect, the techniques further include transmitting configuration information to a first TRP of the multiple TRPS.

In a twenty-first aspect, in combination with the twentieth aspect, the configuration information indicates that the first TRP is to participate in a sensing session and perform a monostatic sensing operation.

In a twenty-second aspect, in combination with the twenty-first aspect, the sensing information received from the first TRP is based on the monostatic sensing operation.

In a twenty-third aspect, in combination with one or more of the first aspect through the nineteenth aspect, the techniques further include transmitting configuration information to a second TRP of the multiple TRPS.

In a twenty-fourth aspect, in combination with the twenty-third aspect, the second TRP is a TRP pair including a transmit TRP and a receive TRP.

In a twenty-fifth aspect, in combination with the twenty-fourth aspect, the configuration information indicates that the second TRP is to participate in a sensing session and perform a bistatic sensing operation.

In a twenty-sixth aspect, in combination with the twenty-fifth aspect, the sensing information received from the second TRP is based on the bistatic sensing operation.

In one or more aspects, techniques for supporting a velocity estimation based on sensing information may include additional aspects, such as any single aspect or any combination of aspects described below or in connection with one or more other processes or devices described elsewhere herein. In a twenty-seventh aspect, techniques for supporting a velocity estimation based on sensing information may include transmitting, to each TRP of a set of TRPs, configuration information. The configuration information indicates sensing scheduling information. The techniques may further include receiving, from each TRP of the set of TRPs, sensing information associated with an object. The sensing information indicates a range value, an angle of arrival, and a time. The techniques may also include determining, based on the sensing information received from the set of TRPs, a velocity of the object. In some examples, the techniques in the twenty-seventh aspect may be implemented in a method or process. In some other examples, the techniques of the twenty-seventh aspect may be implemented in a communication device, which may include a network entity or a component of a network entity. In some examples, the communication device may include at least one processing unit or system (which may include an application processor, a modem or other components) and at least one memory device coupled to the processing unit. The processing unit may be configured to perform operations described herein with respect to the communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a communication interface) that includes a transmitter, a receiver, or a combination thereof. Additionally, or alternatively, the wireless communication device may include one or more means configured to perform operations described herein.

In a twenty-eighth aspect, in combination with the twenty-seventh aspect, the techniques further include transmitting a request to one or more TRPs.

In a twenty-ninth aspect, in combination with the twenty-eighth aspect, the request indicates an object ID of an object, an RF-signature associated with the object, or a combination.

In a thirtieth aspect, in combination with the twenty-eighth aspect or the twenty-ninth aspect, the techniques further include receiving, from at least one TRP of the one or more TRPs, a response to the request.

In a thirty-first aspect, in combination with the thirtieth aspect, the response indicates the object ID, an object detection indicator, a RSRP level associated with the object.

In a thirty-second aspect, in combination with the thirty-first aspect, the techniques further include selecting the set of TRPs from the one or more TRPs based on the response.

In a thirty-third aspect, in combination with one or more of the twenty-seventh aspect through the thirty-second aspect, the set of TRPs includes a single TRP, the network entity includes a core network or a management function, or a combination thereof.

In a thirty-fourth aspect, in combination with one or more of the twenty-seventh aspect through the thirty-second aspect, the set of TRPS includes a first TRP.

In a thirty-fifth aspect, in combination with the thirty-fourth aspect, to receive the sensing information, the techniques further include receiving first sensing information from the first TRP.

In a thirty-sixth aspect, in combination with the thirty-fifth aspect, the first sensing information indicates a first range value, a first angle of arrival, and a first time.

In a thirty-seventh aspect, in combination with the thirty-sixth aspect, to receive the sensing information, the techniques further include receiving second sensing information from the first TRP.

In a thirty-eighth aspect, in combination with the thirty-seventh aspect, the second sensing information indicates a second range value, a second angle of arrival, and a second time.

In a thirty-ninth aspect, in combination with the thirty-eighth aspect, the first time is different from the second time.

In a fortieth aspect, in combination with the thirty-eighth aspect or the thirty-ninth aspect, the set of TRPS includes a second TRP.

In a forty-first aspect, in combination with the fortieth aspect, to receive the sensing information includes the techniques further include receiving third sensing information from the second TRP.

In a forty-second aspect, in combination with the forty-first aspect, the third sensing information indicates a third range value, a third angle of arrival, and a third time.

In a forty-third aspect, in combination with the forty-second aspect, the third time is different from the first time or the second time.

In a forty-fourth aspect, in combination with the thirty-sixth aspect, the set of TRPS includes a second TRP.

In a forty-fifth aspect, in combination with the forty-fourth aspect, to receive the sensing information, the techniques further include receiving third sensing information from the second TRP.

In a forty-sixth aspect, in combination with the forty-fifth aspect, the third sensing information indicates a third range value, a third angle of arrival, and a third time.

In a forty-seventh aspect, in combination with the forty-sixth aspect, the third time is the same as the first time.

In a forty-eighth aspect, in combination with the forty-sixth aspect, the third time is different from the first time.

In a forty-ninth aspect, in combination with one or more of the twenty-seventh aspect through the forty-eighth aspect the set of TRPs is time synchronized, share the same coordinate system, or a combination thereof.

In one or more aspects, techniques for supporting a velocity estimation based on sensing information may include additional aspects, such as any single aspect or any combination of aspects described below or in connection with one or more other processes or devices described elsewhere herein. In a fiftieth aspect, techniques for supporting a velocity estimation based on sensing information may include transmitting, to each TRP of a set of TRPs, configuration information. The configuration information indicates a measurement configuration associated with an object and indicates orientation estimation information. The techniques may further include receiving, from each TRP of the set of TRPs, sensing information associated with a sensing operation performed based on the measurement configuration. The sensing information indicates a velocity of the object determined based on the orientation estimation information. In some examples, the techniques in the fiftieth aspect may be implemented in a method or process. In some other examples, the techniques of the fiftieth aspect may be implemented in a communication device, which may include a network entity or a component of a network entity. In some examples, the communication device may include at least one processing unit or system (which may include an application processor, a modem or other components) and at least one memory device coupled to the processing unit. The processing unit may be configured to perform operations described herein with respect to the communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a communication interface) that includes a transmitter, a receiver, or a combination thereof. Additionally, or alternatively, the wireless communication device may include one or more means configured to perform operations described herein.

In a fifty-first aspect, in combination with the fiftieth aspect the techniques further include determining a final velocity of the object based on, for each TRP of the set of TRPs, the velocity of the object indicated by the sensing information received from the TRP.

In a fifty-second aspect, in combination with the fiftieth aspect or the fifty-first aspect, the orientation estimation information includes one or more models.

In a fifty-third aspect, in combination with the fifty-second aspect, the one or more models including a pose estimation model, an orientation estimation model, or a combination thereof.

In a fifty-fourth aspect, in combination with one or more of the fiftieth aspect through the fifty-third aspect, the techniques further include transmitting a request to one or more TRPs.

In a fifty-fifth aspect, in combination with the fifty-fourth aspect, the request indicates an object ID of the object, an RF-signature associated with the object, or a combination thereof.

In a fifty-sixth aspect, in combination with the fifty-fourth aspect or the fifty-fifth aspect, the techniques further include receiving, from at least one TRP of the one or more TRPs, a response to the request.

In a fifty-seventh aspect, in combination with the fifty-sixth aspect, the response indicates the object ID, an object detection indicator, an RSRP level associated with the object.

In a fifty-eighth aspect, in combination with the fifty-seventh aspect, the techniques further include selecting the set of TRPs from the one or more TRPs based on the response.

In a fifty-ninth aspect, in combination with one or more of the fiftieth aspect through the fifty-eighth aspect, the set of TRPs includes a single TRP.

In one or more aspects, techniques for supporting a velocity estimation based on sensing information may include additional aspects, such as any single aspect or any combination of aspects described below or in connection with one or more other processes or devices described elsewhere herein. In a sixtieth aspect, techniques for supporting a velocity estimation based on sensing information may include receiving, from a network entity, configuration information. The configuration information indicates a measurement configuration associated with an object and indicates orientation estimation information. The techniques may further include transmitting, to the network entity, an indicator associated with a sensing operation performed based on the measurement configuration. The indicator indicates a velocity of the object determined based on the orientation estimation information. In some examples, the techniques in the sixtieth aspect may be implemented in a method or process. In some other examples, the techniques of the sixtieth aspect may be implemented in a wireless communication device, such as TRP, which may include a UE or a component of a UE, or a base station or a component of a base station. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a sixty-first aspect, in combination with the sixtieth aspect, the orientation estimation information includes one or more models.

In a sixty-second aspect, in combination with the sixty-first aspect, the one or more models including a pose estimation model, an orientation estimation model, or a combination thereof.

In a sixty-third aspect, in combination with one or more of the sixtieth aspect through the sixty-second aspect, the techniques further include performing the sensing operation based on the measurement configuration.

In a sixty-fourth aspect, in combination with the sixty-third aspect, the techniques further include determining the velocity of the object based on the sensing operation.

In a sixty-fifth aspect, in combination with one or more of the sixtieth aspect through the sixty-fourth aspect, the techniques further include determining a channel frequency response based on the sensing operation.

In a sixty-sixth aspect, in combination with the sixty-fifth aspect, the techniques further include determining, based on the orientation estimation information, a 3D pose estimate of the object based on the channel frequency response.

In a sixty-seventh aspect, in combination with the sixty-sixth aspect, the techniques further include determining, based on the orientation estimation information, an orientation estimate based on the 3D pose estimate.

In a sixty-eighth aspect, in combination with the sixty-seventh aspect, the techniques further include calculating the velocity of the object based on the orientation estimate.

In a sixty-ninth aspect, in combination with one or more of the sixtieth aspect through the sixty-eighth aspect, the techniques further include receiving, from the network entity, a sensing request that indicates an object ID of the object, an RF-signature associated with the object, or a combination thereof.

In a seventieth aspect, in combination with the sixty-ninth aspect, the techniques further include detecting the object based on the RF-signature.

In a seventy-first aspect, in combination with the seventieth aspect, the techniques further include transmitting, based on detection of the object, a response to the sensing request.

In a seventy-second aspect, in combination with the seventy-first aspect, the response indicates the object ID, an object detection indicator, an RSRP level associated with the object, or a combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-18 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or a combination thereof.

Those of skill would further appreciate that the various illustrative logical blocks, modules, circuits, and algorithm steps described in connection with the disclosure herein may be implemented as electronic hardware, computer software, or a combination of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or a combination of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a network entity, the method comprising:
receiving, from each transmit/receive point (TRP) of multiple TRPs, sensing information that indicates a range associated with an object and Doppler information; and
determining, based on the sensing information received from the multiple TRPs, a velocity of the object.

2. The method of claim 1, wherein:
the sensing information from each TRP of the multiple TRPs includes an angle,
the Doppler information indicates a phase, a Doppler measurement, or a combination thereof,
the network entity includes a user equipment, a network, or a management function, or
a combination thereof.

3. The method of claim 1, further comprising:
determining, based on the sensing information received from a first TRP of the multiple TRPs, a phase indicated by the Doppler information included in the sensing information received from the first TRP; and
calculating a Doppler measurement associated with the first TRP based on the phase.

4. The method of claim 1, further comprising:
associating different ranges of the sensing information from the multiple TRPs to different objects of multiple objects, the multiple objects including the object and another object;
determining a location of the object based on a first range indicated by the sensing information from the multiple TRPs and associated with the object; and
determining a location of the other object based on a second range indicated by the sensing information from the multiple TRPs and associated with the other object.

5. The method of claim 1, further comprising:
determining a location of the object based on at least one range indicated by the sensing information from the multiple TRPs;
determining, for each TRP of the multiple TRPs, a location of the TRP; and
determining, for each TRP of the multiple TRPs, a radial direction of the TRP based on the location of the TRP and the location of the object.

6. The method of claim 5, further comprising:
for each TRP of the multiple TRPS, associating the radial direction of the TRP and a Doppler measurement based on the Doppler information, and
wherein the radial direction of the TRP include a velocity measurement direction of the TRP.

7. The method of claim 6, wherein:
determining the velocity of the object includes performing a least square (LS) operation or a minimum mean-square error (MMSE) operation using the associated radial direction and Doppler measurement for each TRP of the multiple TRPs, and
the velocity of the object includes a vector having multiple components.

8. The method of claim 1, further comprising:
receiving, from an application, a request for the velocity of the object;
transmitting configuration information to each TRP of the multiple TRPs to configure multiple TRPs to participate in a sensing session; and
transmitting, to the application, a report that indicates the velocity of the object.

9. The method of claim 1, further comprising:
transmitting configuration information to a first TRP of the multiple TRPS,
wherein the configuration information indicates that the first TRP is to participate in a sensing session and perform a monostatic sensing operation; and
wherein the sensing information received from the first TRP is based on the monostatic sensing operation.

10. The method of claim 1, further comprising:
transmitting configuration information to a second TRP of the multiple TRPS,
wherein the second TRP is a TRP pair including a transmit TRP and a receive TRP,
wherein the configuration information indicates that the second TRP is to participate in a sensing session and perform a bistatic sensing operation; and
wherein the sensing information received from the second TRP is based on the bistatic sensing operation.

11. A method of wireless communication performed by a network entity, the method comprising:
transmitting, to each transmit/receive point (TRP) of a set of TRPs, configuration information, the configuration information indicates sensing scheduling information;
receiving, from each TRP of the set of TRPs, sensing information associated with an object, the sensing information indicates a range value, an angle of arrival, and a time; and
determining, based on the sensing information received from the set of TRPs, a velocity of the object.

12. The method of claim 11, further comprising:
transmitting a request to one or more TRPs, the request indicates an object ID of an object, a radio frequency (RF)-signature associated with the object, or a combination;
receiving, from at least one TRP of the one or more TRPs, a response to the request, the response indicates the object ID, an object detection indicator, a RSRP level associated with the object; and
selecting the set of TRPs from the one or more TRPs based on the response.

13. The method of claim 11, wherein:
the set of TRPs includes a single TRP,
the network entity includes a core network or a management function, or
a combination thereof.

14. The method of claim 11, wherein:
the set of TRPS includes a first TRP, and
receiving the sensing information includes receiving first sensing information from the first TRP, the first sensing information indicates a first range value, a first angle of arrival, and a first time.

15. The method of claim 14, wherein:
receiving the sensing information includes receiving second sensing information from the first TRP, the second sensing information indicates a second range value, a second angle of arrival, and a second time, and
the first time is different from the second time.

16. The method of claim 15, wherein:
the set of TRPS includes a second TRP,
receiving the sensing information includes receiving third sensing information from the second TRP, the third sensing information indicates a third range value, a third angle of arrival, and a third time, and
the third time is different from the first time or the second time.

17. The method of claim 14, wherein:
the set of TRPS includes a second TRP, and
receiving the sensing information includes receiving third sensing information from the second TRP, the third sensing information indicates a third range value, a third angle of arrival, and a third time.

18. The method of claim 17, wherein the third time is the same as the first time.

19. The method of claim 17, wherein the third time is different from the first time.

20. The method of claim 11, wherein the set of TRPs is time synchronized, share the same coordinate system, or a combination thereof.

21. A method of wireless communication performed by a network entity, the method comprising:
transmitting, to each transmit/receive point (TRP) of a set of TRPs, configuration information, the configuration information indicates a measurement configuration associated with an object and indicates orientation estimation information; and
receiving, from each TRP of the set of TRPs, sensing information associated with a sensing operation performed based on the measurement configuration, the sensing information indicates a velocity of the object determined based on the orientation estimation information.

22. The method of claim 21, further comprising determining a final velocity of the object based on, for each TRP of the set of TRPs, the velocity of the object indicated by the sensing information received from the TRP.

23. The method of claim 21, wherein the orientation estimation information includes one or more models, the one or more models including a pose estimation model, an orientation estimation model, or a combination thereof.

24. The method of claim 21, further comprising:
transmitting a request to one or more TRPs, the request indicates an object ID of the object, an RF-signature associated with the object, or a combination thereof;
receiving, from at least one TRP of the one or more TRPs, a response to the request, the response indicates the object ID, an object detection indicator, a reference signal received power (RSRP) level associated with the object; and
selecting the set of TRPs from the one or more TRPs based on the response.

25. The method of claim 21, wherein the set of TRPs includes a single TRP.

26. A method of wireless communication performed by a transmission/reception point (TRP), the method comprising:
receiving, from a network entity, configuration information, the configuration information indicates a measurement configuration associated with an object and indicates orientation estimation information; and
transmitting, to the network entity, an indicator associated with a sensing operation performed based on the measurement configuration, the indicator indicates a velocity of the object determined based on the orientation estimation information.

27. The method of claim 26, wherein the orientation estimation information includes one or more models, the one or more models including a pose estimation model, an orientation estimation model, or a combination thereof.

28. The method of claim 26, further comprising:
performing the sensing operation based on the measurement configuration; and
determining the velocity of the object based on the sensing operation.

29. The method of claim 26, further comprising:
determining a channel frequency response based on the sensing operation;
determining, based on the orientation estimation information, a 3D pose estimate of the object based on the channel frequency response;
determining, based on the orientation estimation information, an orientation estimate based on the 3D pose estimate; and
calculating the velocity of the object based on the orientation estimate.

30. The method of claim 26, further comprising:
receiving, from the network entity, a sensing request that indicates an object ID of the object, a radio frequency (RF)-signature associated with the object, or a combination thereof;
detecting the object based on the RF-signature; and
transmitting, based on detection of the object, a response to the sensing request, the response indicates the object ID, an object detection indicator, a reference signal received power (RSRP) level associated with the object, or a combination thereof.
